(19) United States
(12) Patent Application Publication
(10) Pub. No.: US 2025/0382173 A1
(43) Pub. Date: Dec. 18, 2025

(54) COMPROPORTIONATION-BASED AUTOCATALYTIC CYCLES AND RELATED METHODS

(71) Applicant: Wisconsin Alumni Research Foundation, Madison, WI (US)

(72) Inventors: Betul Kacar, Madison, WI (US); Zachary Adam, Madison, WI (US)

(73) Assignee: Wisconsin Alumni Research Foundation, Madison, WI (US)

(21) Appl. No.: 19/234,618

(22) Filed: Jun. 11, 2025

Related U.S. Application Data
(60) Provisional application No. 63/660,685, filed on Jun. 17, 2024.

(51) Int. Cl. C01B 17/50; B01J 12/00; B01J 19/00; C01B 17/04; C01B 17/16; C01B 21/36; C01B 21/38; C01B 21/50; C01B 32/40; C01B 32/50

(52) U.S. Cl. CPC C01B 17/508; B01J 12/00; B01J 19/004; C01B 17/0456; C01B 17/161; C01B 21/36; C01B 21/38; C01B 21/50; C01B 32/40; C01B 32/50

(57) ABSTRACT

The present disclosure provides autocatalytic cycles and chemical reactor systems in which the autocatalytic cycles may be conducted. Also provided are methods of identifying the autocatalytic cycles and methods of conducting the autocatalytic cycles, e.g., to produce a desired product. Regarding the methods of conducting the autocatalytic cycles, such a method comprises: carrying out a comproportionation reaction by reacting a first reactant M₁ and a second reactant M₂ to form a product M₃, wherein M₁, M₂, and M₃ each comprise at least one chemical element in common and the product M₃ is produced in stoichiometric excess; and carrying out an auxiliary reaction by converting the product M₃ to M₁ or M₂.

### CROSS REFERENCE TO RELATED APPLICATIONS

The present application claims priority to U.S. Provisional Patent Application No. 63/660,685, filed Jun. 17, 2024, the entire contents of which are incorporated herein by reference.

### REFERENCE TO GOVERNMENT RIGHTS

This invention was made with government support under 2228495 awarded by the National Science Foundation. The government has certain rights in the invention.

### BACKGROUND

Autocatalysis may be defined as the phenomenon where the product of a single- or multi-step reaction also catalyzes that same reaction, and is a shared feature of all living organisms. Reproduction is by definition a form of autocatalysis, and there are numerous examples of autocatalytic relationships that underpin metabolic processes, all of which are regulated by highly specialized organic polymers, e.g., proteins. By contrast, the prevalence of abiotic autocatalytic networks is unknown. In fact, searching for autocatalytic systems is an inherently difficult problem. It has been shown that recognizing autocatalysis in chemical reaction networks is a nondeterministic polynomial-time complete (NP-complete) problem. (Andersen, J. L., et al. J. Syst. Chem. 2012, 3 (1), 1.) If no autocatalytic system is detected in a given reaction network, it is also correspondingly difficult to ascertain whether some reactions might be capable of forming an autocatalytic system by the inclusion of a few more reactions or the provision of new reagents. This analytical opacity presents a specific challenge to identifying autocatalytic cycles in general, including abiotic autocatalytic cycles.

### SUMMARY

The present disclosure provides autocatalytic cycles and chemical reactor systems in which the autocatalytic cycles may be conducted. Also provided are methods of identifying the autocatalytic cycles and methods of conducting the autocatalytic cycles, e.g., to produce a desired product. The autocatalytic cycles are based on comproportionation reactions. The present disclosure is based, at least in part, on the inventors' insight that comproportionation reactions provide a particularly suitable foundation that can be leveraged to form a broad range of autocatalytic cycles. In addition to the particular autocatalytic cycles disclosed herein, the inventors' unique methodology may be used to identify other autocatalytic cycles, all of which may be used in a variety of applications, including for the industrial production of a desired chemical with substantially greater efficiency and economy as compared to conventional chemical manufacturing processes.

In one aspect, a method for conducting an autocatalytic cycle is provided, the method comprising: carrying out a comproportionation reaction by reacting a first reactant M₁ and a second reactant M₂ to form a product M₃, wherein M₁, M₂, and M₃ each comprise at least one chemical element in common and the product M₃ is produced in stoichiometric excess; and carrying out an auxiliary reaction by converting the product M₃ to M₁ or M₂.

In another aspect, a chemical reactor system configured to conduct an autocatalytic cycle is provided, the system comprising a reactor region in which (a) a comproportionation reaction is carried out by reacting a first reactant M₁ and a second reactant M₂ to form a product M₃, wherein M₁, M₂, and M₃ each comprise at least one chemical element in common and the product M₃ is produced in stoichiometric excess; and in which (b) an auxiliary reaction is carried out by converting the product M₃ to M₁ or M₂.

In another aspect, a method of identifying an autocatalytic cycle is provided, the method comprising selecting a comproportionation reaction comprising a first reactant M₁ and a second reactant M₂ capable of chemically reacting to form a product M₃ in stoichiometric excess, wherein M₁, M₂, and M₃ each comprise at least one chemical element in common; and selecting an auxiliary reaction that is capable of converting the product M₃ to the first reactant M₁ or the second reactant M₂.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1C. Conceptualization of Comproportionation-based Autocatalytic Cycles (CompACs). FIG. 1A. For an element/compound M that can take three or more oxidation states (Lo=lowest oxidation state, Med=intermediate oxidation state, Hi=highest oxidation state), comproportionation between oxidized M^{Hi} and reduced M^{Lo} produces two intermediate-state M^{Med} plus any associated waste products (X_{Comp,M}). Note that for some comproportionation reactions, the stoichiometry may be different; for example, one M^{Hi} may comproportionate with two M^{Lo} while consuming an additional food species F_{Comp}: M^{Hi}+2M^{Lo}+F_{Comp}→3M^{Med}+X_{Comp,M}. FIG. 1B. An oxidative auxiliary process utilizes an oxidant to oxidize an M^{Med} to an M^{Hi}; the result is an oxidative CompAC. FIG. 1C. A reductive auxiliary process utilizes a reductant to reduce an M^{Med} to an M^{Lo}; the result is a reductive CompAC. Autocatalysts reside on the cycles and are underlined: intermediate-state (M^{Med}), the most oxidized (M^{Hi}), and the most reduced (M^{Lo}) are shown; oxidant and reductant food species of the auxiliary processes are also named; and the waste products are indicated with X.

FIGS. 2A-2F. Possible mechanisms of ecological interactions between abiotic CompACs to form illustrative networks involving pairs of abiotic CompACs. Abiotic CompACs can be coupled through an array of chemical reaction types. Depending on how a pair of abiotic CompACs are coupled, the relationship between abiotic CompACs can be interpreted as different types of ecological interactions. Note that these examples are not the only mechanisms for these ecological interactions among abiotic autocatalytic systems. Autocatalysts reside on the cycles and are underlined and oxidant and reductant food species, and waste products are labeled as set forth in FIGS. 1A-1C. “M” represents the reactants/products of a first comproportionation reaction while “N” represents the reactants/products of a second comproportionation reaction. FIG. 2A. In a “competitive” abiotic CompAC network, if two oxidative CompACs consume the same oxidant as food for their auxiliary processes, then the CompACs compete for a shared food species. FIG. 2B. A first type of “mutualistic” abiotic CompAC network is formed if the auxiliary process of the oxidative CompAC (M^{Hi}-M^{Med}) and the auxiliary process of the reductive CompAC (N^{Lo}-N^{Med}) recycle a shared oxidant-reductant pair. FIG. 2C. A second type of “mutualistic” abiotic CompAC network is formed if the auxiliary process of one happens to also be the auxiliary process of the other. FIG. 2D. A first type of “predation” abiotic CompAC network is formed in which a predator CompAC (M^{Hi}-M^{Med}) preys on another CompAC (M^{III}-M^{IV}), if the autocatalyst of the latter (M^{III}) is consumed as food by the comproportionation process of the former (M^{I}+M^{III}→2M^{I}+X′_{Comp}). FIG. 2E. A second type of “predation” abiotic CompAC network is formed in which a predator CompAC (M^{Med}-M^{Lo}) preys on another CompAC (N^{Lo}-N^{Med}), if the autocatalyst of the latter (N^{Lo}) is consumed as food by the auxiliary process of the former (M^{Med}+N^{Lo}→M^{Red}+X_{N}). FIG. 2F. A “bistable” CompAC is formed if the autocatalysts (M^{Med} and N^{Med}) of different CompACs (M^{Hi}-M^{Med} and N^{Hi}-N^{Med}) dimerize to form a new chemical species (MN), wherein either the M-dominated or N-dominated state is locally stable.

FIGS. 3A-3B. Autocatalytic dissolution of copper in nitric acid and kinetic separation between food species. FIG. 3A. Direct reaction between HNO₃, Cu, and H⁺ is slow, which “kinetically separates” the food species HNO₃, Cu, and H⁺. FIG. 3B. Autocatalytic dissolution of copper consists of two fast reactions: the comproportionation between HNO₃ (M^{Hi}) and HNO₂ (M^{Lo}) which yields NO₂ (M^{Med}), and the reduction of NO₂ by Cu and H⁺ (reductants) which yields HNO₂.

FIG. 4. Autocatalytic amplification of CO and CO₂ based on spatial separation between food species. Two reactor regions are connected by tunnels with cooling jackets; the right reactor region is heated up to 700-1000° C., while the left reactor region is at room temperature. In the right reactor region, CO₂ (M^{Hi}) is heated and comproportionates with C (M^{Lo}) to produce more CO (M^{Med}); then the hot CO moves to the left reactor region while being cooled down to room temperature. In the left reactor region, CO is oxidized to CO₂ by reacting with I₂O₅ (oxidant), then this room-temperature CO₂ moves to the right reactor region. To initiate the autocatalytic cycle, at least a small amount of CO₂ or CO may be added as a “seed.”

FIG. 5. Autocatalytic amplification of SO₂ and S based on temporal separation between food species. In a periodically open-closed reactor region having timed inlet and outlet valves with some liquid SO₂ (M^{Hi}) present at the beginning, the input of food species H₂S (M^{Lo}) and O₂ (oxidant) are temporally separated such that the direct reaction between them is impossible but the autocatalytic amplification of SO₂ and S (M^{Med}) is still afforded. In step (i), the reactor region is open, receiving H₂S at a temperature between the boiling points of H₂S and SO₂. In step (ii), the reactor region is closed; the comproportionation between H₂S and SO₂ produces S and H₂O. In step (iii), the reactor region is open, releasing H₂O and residual H₂S at a temperature between the boiling points of H₂O and S. (iv) The reactor is open, receiving O₂ at a temperature between the boiling points of O₂ and S. In step (v), the reactor region is closed; S is oxidized to SO₂ by O₂, completing the autocatalytic cycle. In step (vi), the reactor region is open, releasing residual O₂ at a temperature between the boiling points of O₂ and SO₂. Boiling points: O₂<H₂S<SO₂<H₂O<S.

### DETAILED DESCRIPTION

The present disclosure provides autocatalytic cycles and chemical reactor systems in which the autocatalytic cycles may be conducted. Also provided are methods of identifying the autocatalytic cycles and methods of conducting the autocatalytic cycles, e.g., to produce a desired product.

In an embodiment, an autocatalytic cycle comprises (or consists of) a comproportionation reaction coupled to an auxiliary reaction. The comproportionation reaction and the auxiliary reaction are distinct chemical reactions involving the conversion of chemical species (i.e., chemical elements or chemical compounds) to other chemical species.

The comproportionation reaction of the autocatalytic cycle is a chemical reaction comprising a first reactant M₁ and a second reactant M₂ capable of chemically reacting to form a product M₃. The reactants M₁ and M₂ and the product M₃ are generally different chemical species, but they each share at least one chemical element in common. The reaction of M₁ and M₂ produces M₃ in a stoichiometric excess, e.g., M₁+M₂→2M₃, but the exact stoichiometry depends upon the chemical species involved. In addition to M₁ and M₂, additional reactants may be involved in the chemical reaction. Additional reactants may be referred to herein as “food species.” Similarly, in addition to M₃, additional products may be produced from the chemical reaction. Additional products may be referred to herein as “waste species.” In embodiments, the shared chemical element in M₁, M₂, and M₃ exists in a different oxidation state in each of M₁, M₂, and M₃. For example, the shared chemical element in one of M₁ and M₂ may exist in a high oxidation state (highest of M₁, M₂, and M₃), the shared chemical element in the other of M₁ and M₂ may exist in a low oxidation state (lowest of M₁, M₂, and M₃), and the shared chemical element in M₃ may exist in an intermediate oxidation state (intermediate between M₁ and M₂). In such embodiments, the reactants may be referred to as M^{Hi} and M^{Lo} and the product in stoichiometric excess may be referred to as M^{Med}.

The auxiliary reaction of the autocatalytic cycle is a chemical reaction different from the comproportionation reaction, and one that is capable of converting the product M₃ to the first reactant M₁ or the second reactant M₂. Due to this chemical coupling of the comproportionation reaction and the auxiliary reaction, a closed loop, i.e., cycle, is formed. Moreover, because M₃ (which is converted to M₁ or M₂) and M₁ or M₂ (which reacts to produce M₃) function as both products and reactants, the cycle is autocatalytic. M₃ and its conversion mate (i.e., M₁ or M₂) may be referred to as autocatalysts. The other of M₁ and M₂ may be referred to as a food species or “non-catalytic reactant.”

In embodiments, the auxiliary reaction is an oxidation auxiliary reaction comprising an oxidant capable of oxidizing M₃ to M₁ or M₂. In embodiments, the auxiliary reaction is a reduction auxiliary reaction comprising a reductant capable of reducing M₃ to M₁ or M₂. Such auxiliary reactions may be referred to as redox auxiliary reactions. The oxidant and the reductant may be referred to as food species. However, the auxiliary reaction need not be redox auxiliary reaction. An illustrative example of an auxiliary reaction that is not a redox reaction is the auxiliary reaction of cycle B4 in Table 3, below.

The autocatalytic cycle may be characterized by the number of comproportionation reactions and auxiliary reactions as well as the total number of chemical reactions that define the cycle. As many known autocatalytic cycles involve a large number of chemical reactions, e.g., greater than 6, it was unexpected that the inventors' methodology identified numerous comproportionation-based autocatalytic cycles composed of a few reactions, including only two reactions (a single comproportionation reaction and a single auxiliary reaction). However, the present comproportionation-based autocatalytic cycles may comprise a single (i.e., only one) comproportionation reaction or more than one comproportionation reaction (e.g., 2, 3). Similarly, the autocatalytic cycle may comprise a single (i.e., only one) auxiliary reaction or more than one auxiliary reaction (e.g., 2, 3). This includes a single oxidation auxiliary reaction or more than one oxidation auxiliary reaction as well as a single reduction auxiliary reaction or more than one reduction auxiliary reaction. More than one auxiliary reaction may be used, e.g., if more than one chemical reaction is necessary to convert the product M₃ to the first reactant M₁ or the second reactant M₂. In embodiments, the autocatalytic cycle is characterized by its total number of distinct chemical reactions. The total number is at least two, but in embodiments, the total number is no more than 5, no more than 4, or no more than 3. This includes the total number being between 2 and 5, between 2 and 4, as well as 3, or 2.

The autocatalytic cycle may be characterized by the nature of the chemical species participating in the comproportionation reaction(s) and the auxiliary reaction(s). In embodiments, at least one chemical reaction within the autocatalytic cycle comprises an inorganic chemical species and thus, the autocatalytic cycles herein may be referred to as “inorganic” autocatalytic cycles. By “inorganic chemical species” it is meant a chemical species containing a non-carbon atom (the chemical species may include carbon and/or hydrogen, but at least one non-carbon, non-hydrogen atom is also present). This encompasses embodiments in which all chemical reactions within the autocatalytic cycle comprise an inorganic chemical species. This further encompasses embodiments in which at least one chemical reaction within the autocatalytic cycle consists of inorganic chemical species (i.e., none of the chemical species in the at least one chemical reaction is a chemical species containing only carbon and hydrogen). This further encompasses embodiments in which all chemical reactions within the autocatalytic cycle consist of inorganic chemical species (i.e., no chemical species containing only carbon and hydrogen are present). As demonstrated in the Example below, the inorganic chemical species are not particularly limited as the inventors have identified numerous autocatalytic cycles based on chemical elements found throughout the periodic table.

The autocatalytic cycles may also be characterized as being abiotic, by which it is meant that the autocatalytic cycle does not occur as a result of (or involve) a biological catalyst such as an enzyme. In embodiments, none of the underlying chemical reactions, i.e., the comproportionation reaction(s) and the auxiliary reaction(s) that define the autocatalytic cycle occur as part of a living organism's metabolism.

Specific, illustrative autocatalytic cycles are set forth in Tables 1-3, below (it is noted that Table 1 is a representative sampling of a more complete set of autocatalytic cycles included in Table 2). In embodiments, the autocatalytic cycle is as follows (see cycle 130 in Table 2, below):

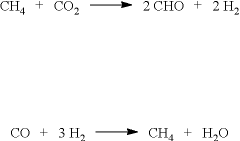

In embodiments, the autocatalytic cycle is as follows (see cycle 49 in Table 2, below):

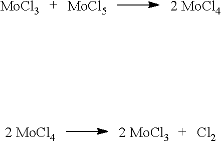

In embodiments, the autocatalytic cycle is as follows (see cycle B35 in Table 3, below):

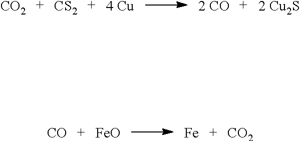

In embodiments, certain reactions are excluded from the autocatalytic cycles, including Belousov-Zhabotinsky reactions. In embodiments, the comproportionation reaction(s) of the autocatalytic cycle does not comprise a chemical species comprising bromine (e.g., bromic acid (HBrO₃)), e.g., as a reactant. In embodiments, the auxiliary reaction(s) of the autocatalytic cycle does not comprise cerium ions, e.g., as an oxidant/reductant. In embodiments, the autocatalytic cycle does not comprise a chemical reaction (which may be either the comproportionation reaction(s) or the auxiliary reaction(s) or both) involving bromic acid and cerium ions as chemical species therein. In embodiments, the autocatalytic cycle is not cycle 209 in Table 2, below

In embodiments, the autocatalytic cycle does not comprise reacting formaldehyde to form glycoaldehyde. In embodiments, the autocatalytic cycle does not comprise oxidizing pyrite in an aqueous solution. In embodiments, the autocatalytic cycle does not comprise oxidizing oxalic acid by permanganate.

In embodiments, the autocatalytic cycle does not comprise a chemical reaction (which may be either the comproportionation reaction(s) or the auxiliary reaction(s) or both) involving iodous acid and chlorous acid as chemical species therein. In embodiments, the autocatalytic cycle is not cycle 215 in Table 2, below.

In embodiments, the autocatalytic cycle does not comprise a chemical reaction (which may be either the comproportionation reaction(s) or the auxiliary reaction(s) or both) involving mercury ions, iron ions, and colloidal mercury as chemical species therein. In embodiments, the autocatalytic cycle is not cycle 103 in Table 2, below.

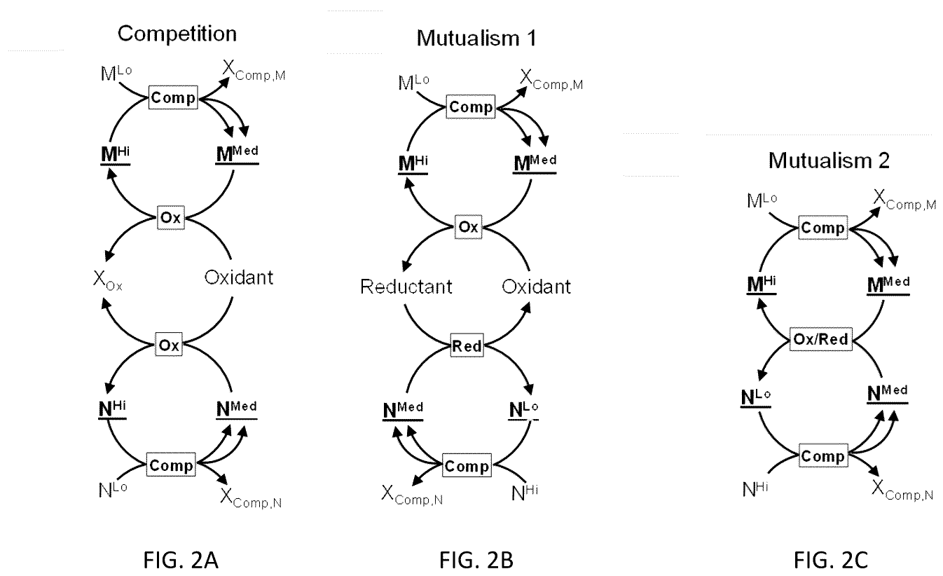

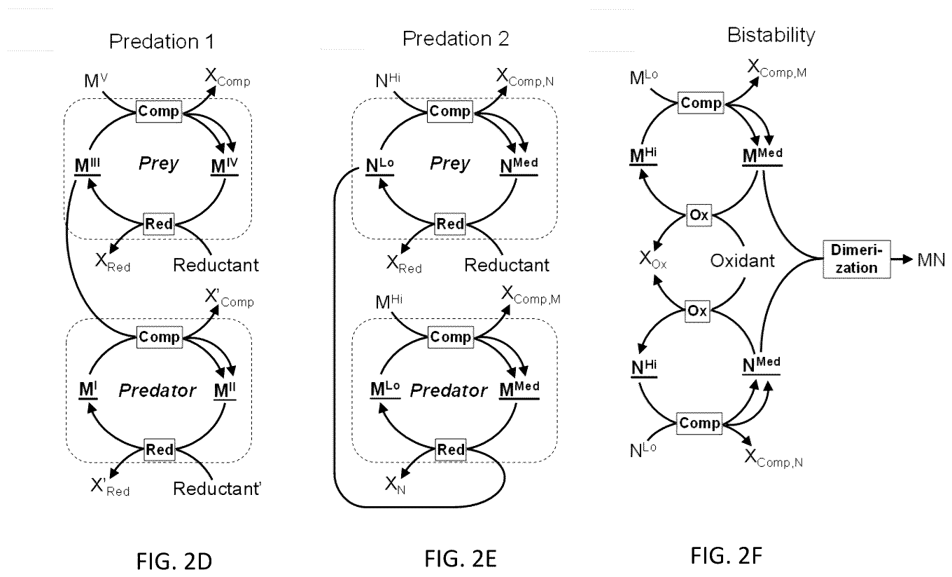

As illustrated in FIGS. 2A-2F, an autocatalytic cycle may comprise at least two different comproportionation reactions (e.g., a pair) and at least one shared chemical species, i.e., a chemical species that participates in at least two different reactions within the cycle. Such autocatalytic cycles, including those shown in FIGS. 2A-2F, may be referred to as “autocatalytic networks.” “M” may be used to identify the reactants/products of the first comproportionation reaction and “N” may be used to identify the second, different comproportionation reaction. (FIG. 2D illustrates an exception in which a first comproportionation reaction involves reactants M^{III} and M^{V} and product M^{IV} and a second comproportionation reaction involves reactants M^{I} and M^{III} and product M^{II}, wherein I-V indicate different oxidation states).

In an illustrative competitive autocatalytic network (e.g., see FIG. 2A), the oxidation auxiliary reactions of the first and second comproportionation reactions comprise the same oxidant. As another illustration (not shown), reduction auxiliary reactions of the first and second comproportionation reactions comprise the same reductant. In an illustrative mutualistic autocatalytic network (e.g., see FIG. 2B), the oxidation auxiliary reaction of one of the first and second comproportionation reactions and the reduction auxiliary reaction of the other of the first and second comproportionation reactions comprise the same oxidant-reductant pair. In another illustrative mutualistic autocatalytic network (e.g., see FIG. 2C), the oxidation auxiliary reaction of one of the first and second comproportionation reactions is the reduction auxiliary reaction of the other of the first and second comproportionation reactions. In an illustrative predation autocatalytic network, an autocatalyst of one of the first and second comproportionation reactions is a food species of the other of the first and second comproportionation reactions. In another illustrative predation autocatalytic network, an autocatalyst of one of the first and second comproportionation reactions is a food species of the auxiliary reaction of the other of the first and second comproportionation reactions. In an illustrative bistable autocatalytic network, an autocatalyst of one of the first and second comproportionation reactions dimerizes with an autocatalyst of the other of the first and second comproportionation reactions to form a stable chemical species.

The present disclosure also encompasses methods of forming or identifying any of the disclosed autocatalytic cycles. In an embodiment, a method of identifying an autocatalytic cycle comprises selecting a comproportionation reaction comprising a first reactant M₁ and a second reactant M₂ capable of chemically reacting to form a product M₃ in stoichiometric excess; and selecting an auxiliary reaction that is capable of converting the product M₃ to the first reactant M₁ or the second reactant M₂. M₁, M₂, M₃ and the auxiliary reaction(s) are as defined above. The methods may be carried out using a device (e.g., a computing device) comprising an input interface, an output interface, a communication interface, a computer-readable medium, a processor, and an application. One or more databases (e.g., of chemical reactions), data repositories for the device, may also be included and operably coupled to the device. The computing device may be configured to carry out a thermodynamic assessment of the identified autocatalytic cycle to determine whether, and what conditions, may be selected to induce the underlying chemical reactions of the autocatalytic cycle. Alternatively, the methods may be carried out as described in the Example, below, which were used to arrive at the autocatalytic cycles listed in Tables 1-3. Thus, such methods may be used to identify other autocatalytic cycles. Confirmation that a “candidate” autocatalytic cycle exhibits autocatalysis may be conducted as described in the Example below, including by measuring acceleration and/or seed-dependence of the comproportionation reaction(s).

The present disclosure also encompasses methods of conducting any of the disclosed autocatalytic cycles. The methods involve carrying out the comproportionation reaction(s) and the auxiliary reaction(s) that define the autocatalytic cycle being conducted. Carrying out these reactions generally involves use of conditions that induce the underlying chemical reactions. The term “conditions” may refer to the environment under which the reactants/products are subjected, including environmental parameters such as temperature, pressure, atmosphere, use of light and its characteristics, flow rate (if applicable), mixing conditions, period of time, etc. The specific choice of environmental parameters depends upon the specific autocatalytic cycle.

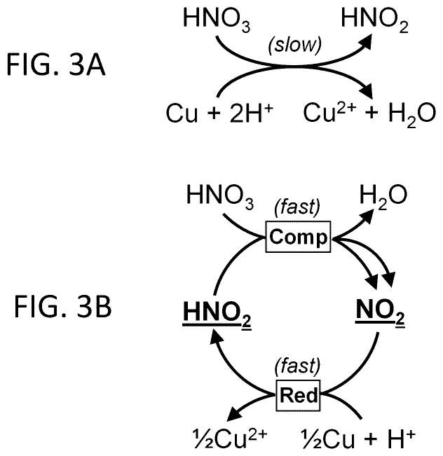

The term “conditions” may also refer to suppression of “side” chemical reactions between non-catalytic reactants and food species of the relevant comproportionation reaction(s) and the auxiliary reaction(s). By way of illustration, an undesired side chemical reaction may be a direct reaction between a non-catalytic reactant of the relevant comproportionation reaction and the oxidant (or reductant) of the relevant auxiliary reaction. As further described below, this is illustrated in FIG. 3A showing an undesired side chemical reaction involving a non-catalytic reactant HNO₃ and reductants Cu, H⁺ of the autocatalytic cycle shown in FIG. 3B.

Suppression of undesired side chemical reactions may involve kinetic separation, spatial separation, temporal separation (or combinations thereof) of certain non-catalytic reactants and food species, including between a non-catalytic reactant of the relevant comproportionation reaction, and the oxidant (or reductant) of the relevant auxiliary reaction.

Kinetic separation is illustrated in FIG. 3A-3B. In this embodiment, kinetic separation is a feature of the particular autocatalytic cycle shown in FIG. 3B. Specifically, as shown in FIG. 3A, the direct reaction between the non-catalytic reactant HNO₃ and the reductants Cu and H⁺ is slow. This enables kinetic separation of this side reaction from the desired comproportionation and reductive auxiliary reactions that make up the autocatalytic cycle shown in FIG. 3B. Kinetic separation may also be facilitated by appropriate selection of environmental parameters, including those noted above.

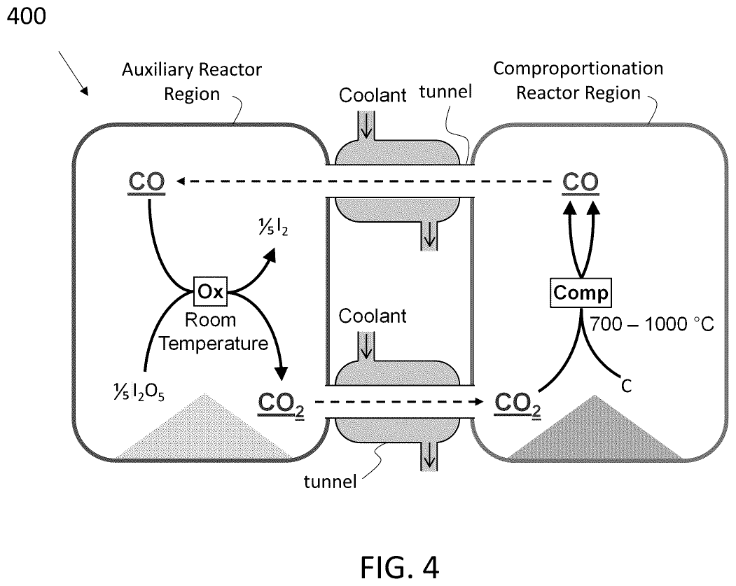

Spatial separation is illustrated in FIG. 4. In this embodiment, spatial separation is achieved by use of a chemical reactor system 400 configured to physically separate certain reactants/products of the autocatalytic cycle. As shown in FIG. 4, this is accomplished by the chemical reactor system 400 comprising two separate reactor regions, one configured to contain reactants/products of the comproportionation reaction (the comproportionation reactor region) and the other configured to contain reactants/products of the auxiliary reaction (the auxiliary reactor region). Regarding the autocatalytic cycle shown in FIG. 4, system 400 physically separates the non-catalytic reactant C from the oxidant I₂O₅ so as to suppress a direct reaction between these species which could obscure autocatalysis. The physical separation also allows the two reactor regions to be independently configured to achieve the appropriate set of environmental parameters which induce the comproportionation reaction (here, an elevated temperature achieved, e.g., by a heater operably connected to the comproportionation reactor region) which may be different from those that induce the auxiliary reaction. In this embodiment, the two reactor regions are in fluid communication with one another via tunnels or channels so as to allow delivery of gaseous reactants therebetween.

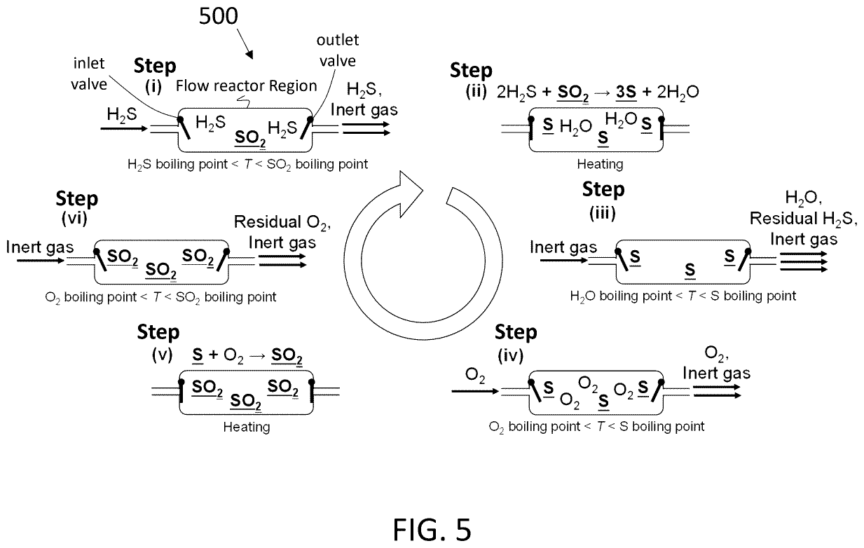

Temporal separation is further illustrated in FIG. 5. In this embodiment, temporal separation is achieved by use of a chemical reactor system 500 configured to temporally separate certain reactants/products of the autocatalytic cycle. As shown in FIG. 5, this is accomplished by the chemical reactor system 500 comprising a flow reactor region through which reactants/products may flow, an inlet valve, an outlet valve, and a controller (not shown) configured to control operation of the inlet and outlet valves according to a certain temporal and temperature profile. The temporal profile is selected such that the non-catalytic reactant H₂S and the oxidant O₂ are not present in the flow reactor region at the same time, thereby suppressing a direct reaction between these species which could obscure autocatalysis. A heater and mass flow controller (not shown) may be part of the system 500. The system 500's configuration (e.g., via the controller, heater, mass flow controller) also ensures that the appropriate set of environmental parameters are achieved so as to induce the comproportionation reaction and the auxiliary rection of the autocatalytic cycle.

Thus, “conditions” may collectively refer to appropriate selection of environmental parameters and chemical reactor system configured to carry out the relevant comproportionation reaction(s) and the auxiliary reaction(s) that define the autocatalytic cycle being conducted. This includes the chemical reactor system being configured to achieve kinetic, spatial, and/or temporal separation as described above.

The present disclosure also encompasses any of the chemical reactor systems described herein. This includes chemical reactor systems configured to achieve kinetic, spatial, and/or temporal separation as described above. However, more generally, the chemical reactor system comprises a reactor region configured to contain the reactants/products of the comproportionation reaction(s) and the auxiliary reaction(s) that define the selected autocatalytic cycle and to induce these reactions. Other components typically included in chemical reactor systems may be used as well as components for achieving an appropriate set of environmental parameters and/or for suppressing side reactions as described above: e.g., separated reactor regions, inlets and outlets for delivering reactants/products to and from the reactor region(s), heaters, controllers, etc.

### Example

### Introduction

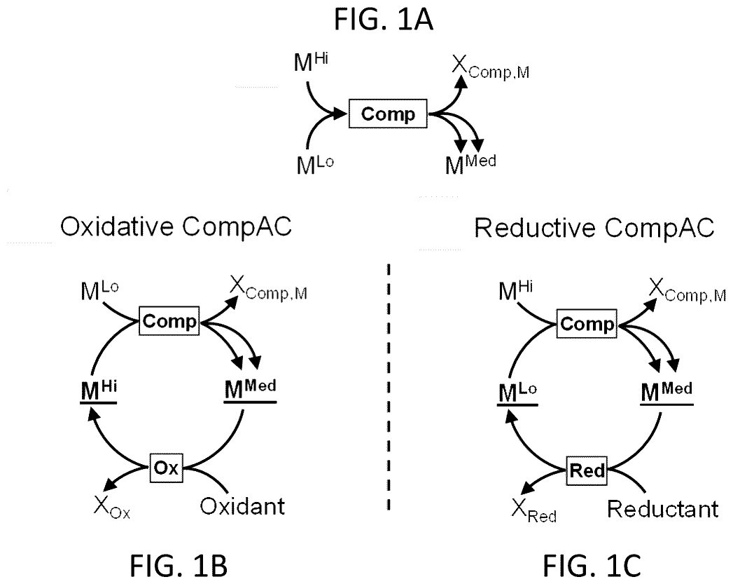

This Example focuses on a specific type of reaction—comproportionation—as a way of enumerating chemical reaction networks with autocatalytic motifs across the periodic table. Comproportionation (alternatively referred to as con-, sym-, or synproportionation) may be defined as when two chemical species containing the same element with different oxidation numbers react to yield a product species with the same intermediate oxidation state (FIG. 1A). In the inventors' view, comproportionation reactions are an interesting basis for assessing autocatalysis because they combine two general attributes of cellular biochemical systems: i) reactions driven by electrochemical potentials (redox reactions) to yield reduced or oxidized product(s) and ii) stoichiometric (potentially autocatalytic) amplification of those products. The inventors' approach to involves identifying a stoichiometric autocatalytic cycle by coupling a comproportionation process with either an auxiliary oxidation (FIG. 1B) or reduction pathway (FIG. 1C) to form a loop that amplifies the intermediate-oxidation-state species and either the most oxidized- or reduced-state species, respectively. Such an autocatalytic cycle in this Example is termed a Comproportionation-based Autocatalytic Cycle (CompAC). Broad-sense CompACs are defined below and a broader definition of “CompAC” encompassing both types of cycles is provided in the detailed description above.

As described below, a specific search strategy for CompACs was developed and this strategy was used to document 226 CompACs across 46 elements. As demonstrated below, each of the 18 groups, lanthanoid series, and actinoid series in the periodic table supports multiple CompACs. (See Tables 1 and 2.) 44 prospective abiotic autocatalytic cycles were also documented that do not necessarily involve redox reactions but can be interpreted as Broad-sense CompACs. “Broad-sense CompAC” makes use of a definition of “comproportionation” that only considers stoichiometry (as opposed to both stoichiometry and oxidation state). (See Table 3.) A full explanation of Broad-sense CompACs is given below. It was demonstrated that autocatalysis is a broadly existing phenomenon, as it can be manifested by multiple sets of reaction rules, under a wide variety of conditions, and through the coordination of relatively small numbers of reactions between simple chemical species. Reconceptualizing the parameter space of environmental conditions under which autocatalytic dynamics can be facilitated enables researchers to access the disclosed autocatalytic cycles under a broad array of laboratory conditions.

### Methods

Following the formalism of CompACs described above (see FIGS. 1A-1C), comproportionation reactions were collated on an element-by-element basis by searching a variety of literature and database sources, including primary literature related to experimentally confirmed reactions as well as secondary literature such as reviews, textbooks, handbooks of chemical reactions and substances, and the Reaxys database (www.reaxys.com). In addition, all candidate reactions retrieved from the Reaxys database were cross-checked with primary literature sources. Auxiliary reaction pathways that lead from the intermediate-oxidation-state product of comproportionation to one of the reactants of comproportionation were similarly collected and collated. It is important to note that although the individual chemical reactions making up a particular CompAC are known to occur, the coupling of the chemical reactions as set forth herein has not been previously considered. Thus, to the inventors' knowledge, none of the CompACs disclosed herein are known. Moreover, it is believed that neither the strategy of leveraging comproportionation reactions to form autocatalytic cycles, nor the coupling of such reactions to an auxiliary oxidation or reduction reaction has been previously considered. The inventors' approach to identifying CompACs brings the advantage of providing a simple and generalized framework for identifying stoichiometric autocatalytic motifs across different elements, according to current knowledge, without explicit reference to terrestrial prebiotic plausibility.

The identification of CompACs was organized into three distinct stages. In Stage 1 (Comproportionation Reaction Search), handbooks of chemical reactions and chemistry textbooks were reviewed to identify individual comproportionation reactions (including broad-sense comproportionation reactions). The main materials used were: ISBN 978-0-12-395590-6; ISBN 978-0-12-395591-3; ISBN 978-0-07-049439-8; ISBN 978-0-19-876812-8; ISBN 978-0-12-352651-9; ISBN 978-7-5369-3374-3; and ISBN 978-5-358-01303-2. When needed, translation tools such as https://www.deep1.com/translator and multilingual technical dictionaries were employed. In addition to these reference volumes, the Reaxys database (https://www.reaxys.com/) was used to search for reactions involving metal oxides, metal chalcogenides, and metal halides, and documented comproportionation reactions.

In Stage 2 (Auxiliary Reaction Search), the handbooks, textbooks, Reaxys database and translation tools described above were used to identify individual auxiliary reactions or reaction pathways that close CompACs, i.e., convert a product of an identified comproportionation reaction to a reactant thereof.

In Stage 3 (Reaction Condition Descriptions and Balanced Reaction Check), using the database assembled from Stages 1 and 2, a search for primary literature corresponding to the records obtained from Reaxys was conducted, specifically using the following websites to find historical literature lacking direct links to Reaxys: https://books.google.com/, https://babel.hathitrust.org/, https://archive.org/, https://gallica.bnf.fr/, https://www.gutenberg.org/. When needed, resources such as https://www.deep1.com/translator and multilingual technical dictionaries were consulted.

### Results

Surprisingly, 226 CompACs were documented across the periodic table. Most do not involve organic molecules. Table 1 shows representative examples while Table 2 shows the extended list.). At least two CompACs were documented for each of the 18 groups, lanthanoid series, and actinoid series in the periodic table. Of these, most CompACs were composed of two reactions, and only eight CompACs consisted of four or more reactions.

Table 1. Representative examples of Comproportionation-based Autocatalytic Cycles (CompACs). The arrows in this table do not mean that the reactions

TABLE 1
Representative examples of Comproportionation-
based Autocatalytic Cycles (CompACs).

| Group or | Count of | |
|---|---|---|
| Series | CompACs | Representative CompAC |
| Group 1 | 8 | NaH + HCl → NaCl + H₂ |
| | | 2 CuCl + H₂ → 2 Cu + 2 HCl |
| Group 2 | 2 | Ca + CaF₂ → 2 CaF |
| | | 3 CaF + Sc → 3 Ca + ScF₃ |
| Lanthanoid | 3 | 2 EuCl₃ + Eu → 3 EuCl₂ |
| | | 2 EuCl₂ + Cl₂ → 2 EuCl₃ |
| Actinoid | 5 | ThO₂ + Th → 2 ThO |
| | | ThO + Si → Th + SiO |
| Group 3 | 2 | 2 YF₃ + Y → 3 YF₂ |
| | | YF₂ + CaF → YF₃ + Ca |
| Group 4 | 4 | TiBr₂ + TiBr₄ → 2 TiBr₃ |
| | | 2 TiBr₃ + 2 HBr → 2 TiBr₄ + H₂ |
| Group 5 | 18 | 2 VCl₃ + V → 3 VCl₂ |
| | | 2 VCl₂ + 2 HCl → 2 VCl₃ + H₂ |
| Group 6 | 11 | Cr₂O₇²⁻ + 6 Cr²⁺ + 14 H⁺ → 8 Cr³⁺ + 7 H₂O |
| | | 2 Cr³⁺ + 3 MnO₂ + 2 H₂O → 2 HCrO₄⁻ + 3 Mn²⁺ + 2 H⁺ |
| | | 2 HCrO₄⁻ → Cr₂O₇²⁻ + H₂O |
| Group 7 | 21 | 2 MnO₄⁻ + 3 Mn²⁺ + 2 H₂O → 5 MnO₂ + 4 H⁺ |
| | | MnO₂ + 2 Fe²⁺ + 4H⁺ → Mn²⁺ + 2 Fe³⁺ + 2 H₂O |
| Group 8 | 5 | Fe + 2 Fe³⁺ → 3 Fe²⁺ |
| | | 2 Fe²⁺ + Cl₂ → 2 Fe³⁺ + 2 Cl⁻ |
| Group 9 | 6 | Co₃O₄ + Co → 4 CoO |
| | | 6 CoO + O₂ → 2 Co₃O₄ |
| Group 10 | 7 | NiS₂ + Ni₃S₂ → 4 NiS |
| | | 3 NiS + H₂ → Ni₃S₂ + H₂S |
| Group 11 | 9 | Cu + Cu²⁺ → 2 Cu⁺ |
| | | Cu⁺ + Fe³⁺ → Cu²⁺ + Fe²⁺ |
| Group 12 | 7 | Hg + Hg²⁺ → Hg₂²⁺ |
| | | Hg₂²⁺ + 2 Fe²⁺ → 2 Hg + 2 Fe³⁺ |
| Group 13 | 14 | 2 B₂O₃ + 2 B → 3 B₂O₂ |
| | | B₂O₂ + 2 H₂ → 2 B + H₂O |
| Group 14 | 22 | C + CO₂ → 2 CO |
| | | 5 CO + I₂O₅ → I₂ + 5 CO₂ |
| Group 15 | 25 | HNO₂ + HNO₃ → 2 NO₂ + H₂O |
| | | 2 NO₂ + Cu + 2 H⁺ → 2 HNO₂ + Cu²⁺ |
| Group 16 | 32 | SO₂ + 2 H₂S → 3 S + 2 H₂O |
| | | S + O₂ → SO₂ |
| Group 17 | 21 | HCl + HOCl → Cl₂ + H₂O |
| | | Cl₂ + H₂ → 2 HCl |
| Group 18 | 4 | XeF₄ + Xe → 2 XeF₂ |
| | | XeF₂ + F₂ → XeF₄ |

The arrows in this table do not mean that the reactions are irreversible but are intended to indicate the autocatalytic direction. Autocatalysts are shown in bold. For the extended list of CompACs, please refer to Table 2, below. Comproportionation reactions are shown by the upper equations, while the auxiliary oxidation or reduction reactions are shown by the lower equations.

As the term “comproportionation” does not necessarily require the reactants and products to follow the oxidation state pattern shown in FIG. 1A, but more generally involves a specific stoichiometric relationship, a “Broad-sense CompAC” category was defined. For example, O₂SC₂+O₂SF₂→2O₂SFCl may be referred to as a comproportionation reaction because atoms of the same element in different reactant species appear in the same product species with stoichiometric excess, even though none of the involved atoms change their oxidation numbers. Therefore, in addition to the “CompAC” formulation, a “Broad-sense CompAC” was also formalized by combining the broader definition of a comproportionation reaction with an auxiliary process. For example, O₂SCl₂+O₂SF₂→2O₂SFCl can be combined with O₂SFCl+KSO₂F→O₂SF₂+KCl+SO₂ to form a Broad-sense CompAC (autocatalysts are shown in bold). On the basis of this formulation, 44 Broad-sense CompACs were documented (Table 3) that are stoichiometrically capable of autocatalysis. Again, most Broad-sense CompACs consist of two reactions, and no Broad-sense CompAC consists of four or more reactions. Taken together, the distribution of CompACs does not reflect an isolated or particularly specialized attribute of elements of any particular group.

Identification of the CompACs helpfully assesses the distribution of autocatalytic stoichiometry throughout the periodic table, but does not consider the thermodynamics of the constituent reactions. Thermodynamic considerations bring to attention two potential issues. First, for a reversible reaction which is a part of a CompAC, its rate constant(s) in the autocatalytic direction may be much smaller than that of the reverse direction under a given set of environmental conditions, such that the autocatalytic process could be very slow or the steady-state concentrations of the autocatalysts could be very small. Second, a CompAC's comproportionation process and its auxiliary process may require very different environmental conditions to make them thermodynamically feasible. However, both of these issues may be addressed by applying a wide range of environmental conditions, or through spatial and temporal mechanisms capable of organizing reactions requiring different conditions into activated CompACs. Such considerations will be discussed below.

### Discussion

Based on the strategy described above, empirically testable CompACs/Broad-sense CompACs were documented in all groups, the lanthanoid series and the actinoid series in the periodic table. This Example focuses on CompACs/Broad-sense CompACs consisting of just a few (mostly two, and no more than five, see Table 2: Serial 146) reactions, to allow for experimentally testing and coupling multiples of them together to form a more complex, ecosystem-like network. The broad prevalence of CompACs/Broad-sense CompACs across the periodic table suggests that, despite the challenges in searching for autocatalysis in any given reaction network, generic chemical circumstances or attributes are likely to exist that are correlated with a potential for autocatalytic behavior.

The composition of many of these CompACs/Broad-sense CompACs (Tables 1-3) at first seem tangentially relevant to living organisms (i.e., as opposed to biotic autocatalytic cycles). Some CompACs/Broad-sense CompACs center involve chemical elements that are absent or very rare in most organisms (e.g., Th and Hg); some are unlikely to occur under ambient terrestrial pressure or temperature conditions; and some produce chemicals that are deleterious or lethal to living organisms. They are nevertheless relevant for exploring the origins of life and the distribution of complex chemical dynamics in various astrochemical and exoplanetary locales. First, the conditions under which life originated may be dramatically different from what living organisms are dealing with today, and extraterrestrial life may be Compacc's very different from life on this planet. Coupling of CompACs/Broad-sense CompACs to organic chemistry, in a variety of different environmental contexts, could encompass a subset of reactions suitable for the sustenance of alternative life-like chemical systems. Secondly, abiotic CompACs/Broad-sense CompACs might have played critical roles during life's emergence but were subsequently lost from living organisms later, becoming the “missing links,” analogous to how construction scaffolds are removed after houses are built. Third, even if some CompACs/Broad-sense CompACs are not relevant to life either as we know it or in a form yet to be known, they may nevertheless generate secondary or tertiary chemical effects that may be misinterpreted as false positive biosignatures. Any and all of these conditions may be leveraged to engineer life-like chemical systems with useful chemosynthetic and information-processing properties.

Emergent Patterns from Interactions between CompACs. As illustrated in FIGS. 2A-2F, being based on redox reactions, different CompACs may be coupled to form autocatalytic networks (FIGS. 2A-2F). For example, the auxiliary processes of two oxidative CompACs may consume the same oxidant, making these CompACs compete for food (FIG. 2A). The auxiliary process of an oxidative CompAC and that of a reductive CompAC may recycle a shared oxidant-reductant pair, making these CompACs mutualistic (FIG. 2B). Mutualism is also possible if the auxiliary process of an oxidative CompAC and that of a reductive CompAC happen to be the same reaction (FIG. 2C). The comproportionation or auxiliary process of a CompAC may consume an autocatalyst of another CompAC as food, synonymizing these CompACs to a predator-prey relationship (FIGS. 2D and 2E). Bistability and the priority effect are also possible, if autocatalysts of different CompACs dimerize to form a new chemical species (FIG. 2F).

In contrast to autocatalytic cycles observed in biochemistry that may involve dozens of reaction steps and/or, CompACs are much simpler since they usually consist of only two or three reactions. Such simplicity may be important for a primitive life-like autocatalytic system to emerge and persist. An autocatalytic cycle with fewer reaction steps tends to have a higher “carrying capacity,” and is more compatible with naturally occurring or laboratory-generated conditions.

### Separation Between Food Species Facilitates the Observation of Autocatalytic Dynamics in the Laboratory.

Although the acceleration of a reaction over time is neither sufficient nor necessary for autocatalysis, it is a phenomenon that is most easily measured in experimental protocols. Another method of observing autocatalysis is to check whether a tiny amount of candidate autocatalysts can be used as a “seed” to trigger a reaction system that produces much more autocatalysts. A CompAC is more likely to exhibit reaction acceleration or seed-dependence when direct reactions between the complementary reductive and oxidative food of the comproportionation and auxiliary steps are suppressed. Based on the CompACs documented herein, there are generally three ways to suppress the direct reaction between oxidative food and reductive food: kinetic, spatial, and temporal separations.

As illustrated in FIGS. 3A-3B, the dissolution of copper in nitric acid shows an example of kinetic separation in an autocatalytic system. Upon addition of a piece of copper metal to a nitric acid solution, the dissolution of copper is slow at the beginning, which is a consequence of the fact that the rate of heterogeneous reaction between Cu and HNO₃ is low (FIG. 3A). As the dissolution reaction continues, nitrous acid (HNO₂) is slowly formed by the reaction between HNO₃, H⁺ and electrons from Cu. Once HNO₂ is formed, it activates a new reaction pathway that is much faster than the direct reaction between the Cu metal and nitric acid (FIG. 3B):

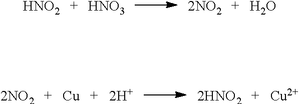

Here, HNO₂ and NO₂ catalyze the formation of themselves through these two fast reactions, and this pathway is thus autocatalytic. Now consider another metal Z in the mixture that directly and quickly reacts with nitric acid; even if Z can be dissolved through the autocatalysis of NO₂ and HNO₂, the autocatalytic dynamics may be obscured. In this case, slowing the reaction between the oxidative food, HNO₃, and the reductive food, metal and H⁺, is important for observing autocatalytic dynamics; the food species are kinetically separated as a consequence of the dramatic differences between the rate constants involved.

Spatial separation may also be used to limit the interaction between oxidative food and reductive food. For example, consider the comproportionation direction of the Boudouard reaction, possible under high temperatures:

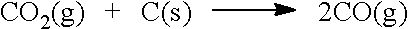

To form a CompAC as described herein, this reaction is coupled with the oxidation of CO by I₂O₅ under room temperature:

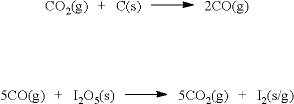

where the autocatalysts CO₂ and CO consume C and I₂O₅ as food, generating I₂ as waste. This CompAC may be difficult to observe experimentally if one simply mixes the food species C and I₂O₅ together in a heated reactor region. This is because I₂O₅ will directly decompose to I₂ and O₂ and/or react with C at temperatures much lower than the desired temperature of CO₂+C→2CO. This competing reaction may obscure the autocatalytic dynamics.

Therefore, one way to experimentally confirm autocatalysis for this this CompAC is to place I₂O₅ and C, which are solids, in two separate reactor regions (a comproportionation reactor region and an auxiliary reactor region) connected by two tunnels configured to only allow the diffusion of gaseous molecules. (See FIG. 4.) The I₂O₅ reactor region is further kept low while that of the C reactor region is kept high, and the tunnels are surrounded by cooling jackets. This chemical reactor system is configured to spatially separate the I₂O₅ and C such that each is maintained at the appropriate reaction conditions and cannot directly react with each other. To initiate the conversion of I₂O₅ and C into CO₂ and CO, a small amount of CO₂ or CO gas may be introduced to the appropriate reactor region or tunnel as a “seed.” With CO₂ as the seed, C will first react with CO₂ to produce more CO by CO₂+C→2CO in the hot reactor region. The hot CO gas will then move mainly through the upper tunnel and be cooled down, eventually making contact with I₂O₅ in the other reactor region and reacting to regenerate CO₂ by 5CO+I₂O₅→5CO₂+I₂. Then the low-temperature CO₂ will move mainly through the lower tunnel to enter the hot reactor region. As this process continues, more and more CO₂ and CO will be synthesized within the connected reactor regions by autocatalysis.

Compared to kinetic separation, spatial separation is useful to not only inhibit direct and rapid reactions between food species, but also to organize reactions that require very different conditions into an autocatalytic cycle. In abiotic environments, spatial separation may occur in multiple forms. For example, if an autocatalytic cycle needs food from hydrothermal vents and the atmosphere, the food species can be separated by the body of water above the vents; if the food species are from different minerals, they can be separated by geographical barriers, such as mountains and rivers, or by simple spacing between different rocks or ores.

If the physicochemical conditions are insufficient to afford effective kinetic or spatial separation, then temporal separation between food species may also be used. For example, consider the CompAC:

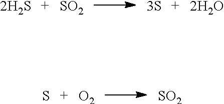

where the autocatalysts SO₂ and S consume H₂S and O₂, generating H₂O as a waste product. Autocatalysis in this CompAC may be experimentally confirmed using the chemical reactor system shown in FIG. 5 employing a reactor region having timed inlet and outlet valves. Specifically, the reactor region may be seeded by a small amount of liquid SO₂ blanketed by an inert gas (e.g., N₂) and the timed inlet and outlet valves operated so that the reactor region periodically receives and releases gaseous molecules in the following pattern: In step (i), H₂S is received at a temperature between the boiling points of H₂S and SO₂; in step (ii), the reactor region is closed at a temperature high enough to allow for 2H₂S+SO₂→3S+2H₂O; in step (iii), gases are released at a temperature between the boiling points of H₂O and S; in step (iv), O₂ is received at a temperature between the boiling points of O₂ and S; in step (v), the reactor region is closed at a temperature high enough to allow for S+O₂→SO₂; in step (vi), gases are released at a temperature between the boiling points of 02 and SO₂, and then starting over at step (i).

Under these periodically changing environmental conditions, wherein the food species H₂S and O₂ are provided at different, non-overlapping time intervals (i.e., temporally separated), the observation of autocatalytic amplification of SO₂ and S may be achieved. In a natural environment, temporal separation may appear in multiple forms, such as intermittent raining, tidal cycles, geyser eruptions, a diurnal cycle, or secondary weathering or runoff patterns that lead to chemical oscillations.

As a basis for comparison, each of these three types of separation is utilized in essential ways by living organisms. For example, CO₂ and H₂O are kinetically separated during photosynthesis; otherwise, CO₂ and H₂O will spontaneously react to produce monosaccharides under sunlight. Intracellular compartments (e.g., the nucleus or the mitochondria in eukaryotes) or macromolecular centralization of multifaceted processes (e.g., ribosomal subunit interactions) can provide a microscopic structural basis of spatial separation. Temporal separation can be mediated by vegetative growth and reproductive growth. One underexplored implication for prebiotic chemistry is that a stoichiometric capability for abiotic autocatalysis may be relatively common across elements, but circumstances facilitating effective separation of key food species and reactions may be a more substantial bottleneck to actualizing autocatalytic dynamics under most cosmochemical and geochemical conditions.

Implications for Biosignature Interpretation. One of the most challenging aspects of assessing the existence of life beyond Earth is the possibility that chemical conditions on remotely sensed bodies may generate complex variations that resemble biotic influence. Autocatalytic cycles in general, and key reactions that compose CompACs in particular, may present significant challenges to biosignature characterization under conditions of pressure, temperature, and energy input that exoplanets can facilitate. The collated list of CompACs provided herein serves as a useful compendium for alternative chemical systems to be compared to remote sensing data in the event that anomalous compositions or redox disequilibria are detected.

Another question relevant to both biosignature characterization and evolutionary biology is the extent to which bioessential inorganic cofactors are utilized as a result of selection among many possible options, or whether they are more likely to be imprinted upon biology through a broader planetary or physicochemical context. Recent studies of reconstructed ancestral metal cofactor binding sites have provided reasonable cause for scrutinizing facile assumptions that link biological utilization to general environmental abundance. Responsive chemical dynamics afforded by autocatalysis are potentially impactful to biochemistry whether incorporated within the cell or mediated through external interactions. One intriguing possibility is that the same basic properties of the redox-active class of metal cofactors (e.g. iron, copper, manganese, molybdenum, etc.) that can support complex comproportionation-driven chemical dynamics are, in parallel, coincident with their propensity for biological utilization. In this view, organic chemistry may open novel possibilities for chemical separation (kinetic, temporal, or spatial) that lack geochemical counterparts. To better assess which chemical species played more critical roles during the origins or early evolution of life, theoretical analyses based on principles of chemistry and empirical data obtained by geochemical studies can be leveraged. For example, one may test whether an element with more oxidation states and a Frost diagram where the curve is generally more concave up is more likely to underlie complex dynamics based on CompACs, and then to test these attributes against the probability of biological uptake.

### CONCLUSIONS

This Example has demonstrated that abiotic autocatalytic reaction systems underpinned by comproportionation (i.e., CompACs) are more frequent than previously known and notably, that the presence of CompACs is not restricted to a specific part of the periodic table. This Example shows that CompACs and their networks are likely a general phenomenon rather than a collection of special cases.

In addition to the CompACs and their networks having use in applications such as chemical manufacturing, the collated CompACs establish a starting point for a systematic assessment of the conditions under which complicated dynamics afforded by autocatalysis can occur in geochemical or cosmochemical settings that are relevant to the search for life in the universe. Such a systematic assessment may be necessary for pushing forward the understanding of abiogenesis, for disentangling false positive biosignatures from bona fide ones, and for circumscribing conditions suitable for the organization of complex chemical systems in general.

TABLE 2
Extended List of Comproportionation-based Autocatalytic Cycles.

| Serial | Elements | Reactions |
|---|---|---|
| 1 | ₁H | SiHCl₃ + HCl → SiCl₄ + H₂ |
| | Group 1 | H₂ + Cl₂ → 2 HCl |
| 2 | ₁H | NaH + HCl → NaCl + H₂ |
| | Group 1 | H₂ + Cl₂ → 2 HCl |
| 3 | ₁H | NaH + HCl → NaCl + H₂ |
| | Group 1 | 2 CuCl + H₂ → 2 Cu + 2 HCl |
| 4 | ₁H | NaH + H₂O → NaOH + H₂ |
| | Group 1 | H₂ + 2 Na → 2 NaH |
| 5 | ₁H | 2 H₂O + NaBH₄ → 4 H₂ + NaBO₂ |
| | Group 1 | H₂ + CuO → H₂O + Cu |
| 6 | ₁H | 2 1/3 H₂O + NaBH₄ → 4 H₂ + NaBO₂•⅓H₂O |
| | Group 1 | H₂ + CuO → H₂O + Cu |
| 7 | ₁H | 2 HCl + 2 NaBH₄ → 2 NaCl + B₂H₆ + 2 H₂ |
| | Group 1 | H₂ + 2 FeCl₃ → 2 HCl + 2 FeCl₂ |
| 8 | ₁H | 2 HCl + 2 NaBH₄ → 2 NaCl + B₂H₆ + 2 H₂ |
| | Group 1 | 4 H₂ + 2 ZrCl₄ + N₂ → 8 HCl + 2 ZrN |
| 9 | ₂₀Ca | Ca + CaF₂ → 2 CaF |
| | Group 2 | 3 CaF + Sc → 3 Ca + ScF₃ |
| 10 | ₅₆Ba | BaCl₂ + Ba → 2 BaCl |
| | Group 2 | 2 BaCl + 2 H₂O → BaCl₂ + Ba(OH)₂ + H₂ |
| | | Ba(OH)₂ + 2 HCl → BaCl₂ + 2 H₂O |
| 11 | ₅₇La | 2 LaI₃ + La → 3 LaI₂ |
| | Ln | LaI₂ + ThI₄ → LaI₃ + ThI₃ |
| 12 | ₆₃Eu | 2 EuCl₃ + Eu → 3 EuCl₂ |
| | Ln | 2 EuCl₂ + Cl₂ → 2 EuCl₃ |
| 13 | ₆₃Eu | Eu₂O₃ + Eu → 3 EuO |
| | Ln | 6 EuO + O₂ → 2 Eu₃O₄ |
| | | 4 Eu₃O₄ + O₂ → 6 Eu₂O₃ |
| 14 | ₉₀Th | ThO₂ + Th → 2 ThO |
| | An | ThO + Si → Th + SiO |
| 15 | ₉₀Th | ThI₄ + ThI₂ → 2 ThI₃ |
| | An | 4 ThI₃ → Th + 3 ThI₄ |
| 16 | ₉₀Th | ThI₄ + Th → 2 ThI₂ |
| | An | ThI₂ + UI₄ → ThI₃ + UI₃ |
| | | 4 ThI₃ → Th + 3 ThI₄ |
| 17 | ₉₀Th | 3 ThI₄ + Th → 4 ThI₃ |
| | An | 2 ThI₃ → ThI₂ + ThI₄ |
| | | ThI₂ + UI₄ → ThI₃ + UI₃ |
| 18 | ₉₂U | 3 UF₄ + U → 4 UF₃ |
| | An | UF₃ + CaF → UF₄ + Ca |
| 19 | ₂₁Sc | 2 ScCl₃ + Sc₅Cl₈ → 7 ScCl₂ |
| | Group 3 | 3 ScCl₂ → 2 ScCl₃ + Sc |
| 20 | ₃₉Y | 2 YF₃ + Y → 3 YF₂ |
| | Group 3 | YF₂ + CaF → YF₃ + Ca |
| 21 | ₂₂Ti | Ti + 3 TiBr₄ → 4 TiBr₃ |
| | Group 4 | 2 TiBr₃ + 2 HBr → 2 TiBr₄ + H₂ |
| 22 | ₂₂Ti | TiBr₂ + TiBr₄ → 2 TiBr₃ |
| | Group 4 | 2 TiBr₃ + 2 HBr → 2 TiBr₄ + H₂ |
| 23 | ₄₀Zr | 3 ZrCl₄ + Zr → 4 ZrCl₃ |
| | Group 4 | 2 ZrCl₃ + 2 HCl → 2 ZrCl₄ + H₂ |
| 24 | ₄₀Zr | ZrI₄ + ZrI₂ → 2 ZrI₃ |
| | Group 4 | 4 ZrI₃ → 3 ZrI₄ + Zr |
| 25 | ₂₃V | V₂O₃ + V → 3 VO |
| | Group 5 | 4 VO + O₂ → 2 V₂O₃ |
| 26 | ₂₃V | V₂O₅ + V₂O₃ → 4 VO₂ |
| | Group 5 | 4 VO₂ + O₂ → 2 V₂O₅ |
| 27 | ₂₃V | V₂O₅ + V₂O₃ → 4 VO₂ |
| | Group 5 | 2 VO₂ + H₂ → V₂O₃ + H₂O |
| 28 | ₂₃V | V₂O₅ + V₂O₃ → 4 VO₂ |
| | Group 5 | 2 VO₂ + CO → V₂O₃ + CO₂ |
| 29 | ₂₃V | 2 VCl₃ + V → 3 VCl₂ |
| | Group 5 | 2 VCl₂ + 2 HCl → 2 VCl₃ + H₂ |
| 30 | ₂₃V | 2 VCl₃ + V → 3 VCl₂ |
| | Group 5 | VCl₂ + H₂ → V + 2 HCl |
| 31 | ₂₃V | 3 VCl₄ + V → 4 VCl₃ |
| | Group 5 | 2 VCl₃ + Cl₂ → 2 VCl₄ |
| 32 | ₂₃V | 3 VCl₄ + V → 4 VCl₃ |
| | Group 5 | 2 VCl₃ + 3 H₂ → 2 V + 6 HCl |
| 33 | ₂₃V | 2 V³⁺ + V → 3 V²⁺ |
| | Group 5 | 2 V²⁺ + H₂O₂ + 2 H⁺ → 2 V³⁺ + 2 H₂O |
| 34 | ₄₁Nb | 2 NbCl₃ + Nb → 3 NbCl₂ |
| | Group 5 | NbCl₂ + H₂ → Nb + 2 HCl |
| 35 | ₄₁Nb | 3 NbCl₅ + 2 Nb → 5 NbCl₃ |
| | Group 5 | 2 NbCl₃ + 3 H₂ → 2 Nb + 6 HCl |
| 36 | ₄₁Nb | 4 NbCl₅ + Nb → 5 NbCl₄ |
| | Group 5 | 2 NbCl₄ + Cl₂ → 2 NbCl₅ |
| 37 | ₄₁Nb | 4 NbCl₅ + Nb → 5 NbCl₄ |
| | Group 5 | 2 NbCl₄ + 2 CCl₄ → 2 NbCl₅ + C₂Cl₆ |
| 38 | ₄₁Nb | 2 Nb₂O₅ + Nb → 5 NbO₂ |
| | Group 5 | 4 NbO₂ + O₂ → 2 Nb₂O₅ |
| 39 | ₄₁Nb | Nb₂O₅ + 3 Nb → 5 NbO |
| | Group 5 | 4 NbO + 3 O₂ → 2 Nb₂O₅ |
| 40 | ₄₁Nb | NbO₂ + Nb → 2 NbO |
| | Group 5 | 3 NbO + CO → 2 NbO₂ + NbC |
| 41 | ₇₃Ta | 4 TaCl₅ + Ta → 5 TaCl₄ |
| | Group 5 | TaCl₄ + NbCl₅ → NbCl₄ + TaCl₅ |
| 42 | ₇₃Ta | TaCl₅ + TaCl₃ → 2 TaCl₄ |
| | Group 5 | TaCl₄ + NbCl₅ → NbCl₄ + TaCl₅ |
| 43 | ₂₄Cr | Cr₂O₇²⁻ + 6 Cr²⁺ + 14 H⁺ → 8 Cr³⁺ + 7 H₂O |
| | Group 6 | 2 Cr³⁺ + 3 MnO₂ + 2 H₂O → 2 HCrO₄⁻ + 3 Mn²⁺ + 2 H⁺ |
| | | 2 HCrO₄⁻ → Cr₂O₇²⁻ + H₂O |
| 44 | ₂₄Cr | 2 CrCl₃ + Cr → 3 CrCl₂ |
| | Group 6 | 2 CrCl₂ + 2 HCl → 2 CrCl₃ + H₂ |
| 45 | ₂₄Cr | 2 CrCl₃ + Cr → 3 CrCl₂ |
| | Group 6 | 2 CrCl₂ + Cl₂ → 2 CrCl₃ |
| 46 | ₂₄Cr | CrCl₂ + CrCl₄ → 2 CrCl₃ |
| | Group 6 | 2 CrCl₃ + Cl₂ → 2 CrCl₄ |
| 47 | ₂₄Cr | CrCl₂ + CrCl₄ → 2 CrCl₃ |
| | Group 6 | 2 CrCl₃ → 2 CrCl₂ + Cl₂ |
| 48 | ₄₂Mo | Mo₂(HPO₄)₄⁴⁻ + Mo₂(HPO₄)₄²⁻ → 2 Mo₂(HPO₄)₄³⁻ |
| | Group 6 | 2 Mo₂(HPO₄)₄³⁻ + 2 H⁺ → 2 Mo₂(HPO₄)₄²⁻ + H₂ |
| 49 | ₄₂Mo | MoCl₃ + MoCl₅ → 2 MoCl₄ |
| | Group 6 | 2 MoCl₄ → 2 MoCl₃ + Cl₂ |
| 50 | ₄₂Mo | MoBr₂ + MoBr₄ → 2 MoBr₃ |
| | Group 6 | 2 MoBr₃ → 2 MoBr₂ + Br₂ |
| 51 | ₇₄W | 2 WCl₆ + W(CO)₆ → 3 WCl₄ + 6 CO |
| | Group 6 | WCl₄ + Cl₂ → WCl₆ |
| 52 | ₇₄W | 2 WCl₆ + W(CO)₆ → 3 WCl₄ + 6 CO |
| | Group 6 | WCl₄ + 2 H₂S → WS₂ + 4 HCl |
| | | WS₂ + 3 Cl₂ → WCl₆ + S₂ |
| 53 | ₇₄W | 49 WO₃ + 5 W → 3 W₁₈O₄₉ |
| | Group 6 | 2 W₁₈O₄₉ + 5 O₂ → 36 WO₃ |
| 54 | ₂₅Mn | 2 KMnO₄ + 3 MnSO₄ + 2 H₂O → 5 MnO₂ + K₂SO₄ + 2 H₂SO₄ |
| | Group 7 | 2 MnO₂ + 2 H₂SO₄ → 2 MnSO₄ + O₂ + 2 H₂O |
| 55 | ₂₅Mn | 2 MnO₄⁻ + 3 Mn²⁺ + 2 H₂O → 5 MnO₂ + 4 H⁺ |
| | Group 7 | MnO₂ + 2 Fe²⁺ + 4 H⁺ → Mn²⁺ + 2 Fe³⁺ + 2 H₂O |
| 56 | ₂₅Mn | 2 KMnO₄ + 3 MnSO₄ + 8 H₂SO₄ → 5 Mn(SO₄)₂ + K₂SO₄ + 8 H₂O |
| | Group 7 | Mn(SO₄)₂ + 2 KI → MnSO₄ + K₂SO₄ + I₂ |
| 57 | ₂₅Mn | 2 MnO₄⁻ + 3 Mn²⁺ + 7 H₂O → 5 MnO(OH)₂ + 4 H⁺ |
| | Group 7 | 2 MnO(OH)₂ + 10 H⁺ + 3 BiO₃⁻ → 2 MnO₄⁻ + 3 Bi³⁺ + 7 H₂O |
| 58 | ₂₅Mn | 2 KMnO₄ + MnO₂ + 4 KOH → 3 K₂MnO₄ + 2 H₂O |
| | Group 7 | 2 K₂MnO₄ + Cl₂ → 2 KMnO₄ + 2 KCl |
| 59 | ₂₅Mn | 2 KMnO₄ + MnO₂ + 4 KOH → 3 K₂MnO₄ + 2 H₂O |
| | Group 7 | K₂MnO₄ + Cl₂ → MnO₂ + 2 KCl + O₂ |
| 60 | ₂₅Mn | K₂MnO₄ + MnSO₄ → 2 MnO₂ + K₂SO₄ |
| | Group 7 | MnO₂ + H₂SO₃ → MnSO₄ + H₂O |
| 61 | ₂₅Mn | K₂MnO₄ + MnSO₄ → 2 MnO₂ + K₂SO₄ |
| | Group 7 | 3 MnO₂ + KClO₃ + 3 K₂CO₃ → 3 K₂MnO₄ + KCl + 3 CO₂ |
| 62 | ₂₅Mn | MnO₄²⁻ + Mn²⁺ → 2 MnO₂ |
| | Group 7 | MnO₂ + BiO₃⁻ + H₂O → MnO₄²⁻ + Bi³⁺ + 2 OH⁻ |
| 63 | ₂₅Mn | MnO₄³⁻ + MnO⁴⁻ → 2 MnO₄²⁻ |
| | Group 7 | 2 MnO₄²⁻ + HCOO⁻ + OH⁻ → 2 MnO₄³⁻ + H₂O + CO₂ |
| 64 | ₂₅Mn | MnO₄³⁻ + MnO₄⁻ → 2 MnO₄²⁻ |
| | Group 7 | MnO₄²⁻ + MnO₂ + 4 OH⁻ → 2 MnO₄³⁻ + 2 H₂O |
| 65 | ₂₅Mn | MnO₄³⁻ + MnO₄⁻ → 2 MnO₄²⁻ |
| | Group 7 | 2 MnO₄²⁻ + SO₃²⁻ + 2 OH⁻ → 2 MnO₄³⁻ + SO₄²⁻ + H₂O |
| 66 | ₂₅Mn | MnSO₄ + Mn(SO₄)₂ → Mn₂(SO₄)₃ |
| | Group 7 | Mn₂(SO₄)₃ + HOOC—COOH → 2 MnSO₄ + H₂SO₄ + 2 CO₂ |
| 67 | ₂₅Mn | Mn(OH)₂ + H₂MnO₃ → Mn₂O₃ + 2 H₂O |
| | Group 7 | 2 Mn₂O₃ + 4 H₂SO₄ → 4 MnSO₄ + O₂ + 4 H₂O |
| | | MnSO₄ + 2 NH₃•H₂O → Mn(OH)₂ + (NH₄)₂SO₄ |
| 68 | ₂₅Mn | MnO₂ + 2 Mn(OH)₂ → Mn₃O₄ + 2 H₂O |
| | Group 7 | 4 Mn₃O₄ + O₂ → 6 Mn₂O₃ |
| | | 2 Mn₂O₃ + O₂ → 4 MnO₂ |
| 69 | ₇₅Re | 3 Re₂O₇ + Re → 7 ReO₃ |
| | Group 7 | 4 ReO₃ + O₂ → 2 Re₂O₇ |
| 70 | ₇₅Re | 2 Re₂O₇ + 3 Re → 7 ReO₂ |
| | Group 7 | 4 ReO₂ + 3 O₂ → 2 Re₂O₇ |
| 71 | ₇₅Re | Re₂O₇ + ReO₂ → 3 ReO₃ |
| | Group 7 | 4 ReO₃ + O₂ → 2 Re₂O₇ |
| 72 | ₇₅Re | 3 Re₂O₇ + Re → 7 ReO₃ |
| | Group 7 | ReO₃ + 3 H₂ → Re + 3 H₂O |
| 73 | ₇₅Re | Re + 2 ReO₃ → 3 ReO₂ |
| | Group 7 | Re₂O₇ + ReO₂ → 3 ReO₃ |
| 74 | ₇₅Re | 2 ReF₆ + Re → 3 ReF₄ |
| | Group 7 | ReF₄ → Re + 2 F₂ |
| 75 | ₂₆Fe | Fe + 2 Fe³⁺ → 3 Fe²⁺ |
| | Group 8 | 2 Fe²⁺ + Cl₂ → 2 Fe³⁺ + 2 Cl⁻ |
| 76 | ₂₆Fe | Fe + 2 Fe³⁺ → 3 Fe²⁺ |
| | Group 8 | Fe²⁺ + Zn → Fe + Zn²⁺ |
| 77 | ₂₆Fe | Fe + 2 Fe³⁺ → 3 Fe²⁺ |
| | Group 8 | Fe²⁺ + CO₃²⁻ → FeCO₃ |
| | | FeCO₃ → FeO + CO₂ |
| | | FeO + CO → Fe + CO₂ |
| 78 | ₂₆Fe | Fe₂O₃ + Fe → 3 FeO |
| | Group 8 | 4 FeO + O₂ → 2 Fe₂O₃ |
| 79 | ₂₆Fe | Fe₂O₃ + Fe → 3 FeO |
| | Group 8 | FeO + CO → Fe + CO₂ |
| 80 | ₂₇Co | CoSi₂ + Co → 2 CoSi |
| | Group 9 | CoSi + Si → CoSi₂ |
| 81 | ₂₇Co | CoSi₂ + Co₂Si → 3 CoSi |
| | Group 9 | CoSi + Si → CoSi₂ |
| 82 | ₂₇Co | CoSi₂ + Co₂Si → 3 CoSi |
| | Group 9 | CoSi + Co → Co₂Si |
| 83 | ₂₇Co | Co₃O₄ + Co → 4 CoO |
| | Group 9 | CoO + CO → Co + CO₂ |
| 84 | ₂₇Co | Co₃O₄ + Co → 4 CoO |
| | Group 9 | 6 CoO + O₂ → 2 Co₃O₄ |
| 85 | ₂₇Co | Co + 2 Co(OH)₃ + 6 CH₃COOH + 6 H₂O → 3 |
| | Group 9 | Co(CH₃COO)₂•4H₂O |
| | | Co(CH₃COO)₂•4H₂O → Co²⁺ + 2 CH₃COO⁻ + 4 H₂O |
| | | Co²⁺ + 2 BH₄⁻ + 6 H₂O → Co + 2 B(OH)₃ + 7 H₂ |
| 86 | ₂₈Ni | NiO₂ + Ni(OH)₂ → 2 NiOOH |
| | Group 10 | 2 NiOOH + Fe + 2 H₂O → Fe(OH)₂ + 2 Ni(OH)₂ |
| 87 | ₂₈Ni | NiSi₂ + Ni₂Si → 3 NiSi |
| | Group 10 | NiSi + Si → NiSi₂ |
| 88 | ₂₈Ni | NiS₂ + Ni₃S₂ → 4 NiS |
| | Group 10 | NiS + H₂S → NiS₂ + H₂ |
| 89 | ₂₈Ni | NiS₂ + Ni₃S₂ → 4 NiS |
| | Group 10 | 3 NiS + H₂ → Ni₃S₂ + H₂S |
| 90 | ₂₈Ni | Ni + Ni₂O₃ → 3 NiO |
| | Group 10 | NiO + CO → Ni + CO₂ |
| 91 | ₂₈Ni | Ni + Ni₂O₃ → 3 NiO |
| | Group 10 | 4 NiO + O₂ → 2 Ni₂O₃ |
| 92 | ₂₈Ni | Ni + 2 Ni(OH)₃ + 6 CH₃COOH + 6 H₂O → 3 Ni(CH₃COO)₂•4H₂O |
| | Group 10 | Ni(CH₃COO)₂•4H₂O → 0.86Ni(CH₃COO)₂•0.14Ni(OH)₂ + 0.28 |
| | | CH₃COOH + 3.72 H₂O |
| | | 0.86Ni(CH₃COO)₂•0.14Ni(OH)₂ → NiO + 0.86 CH₃COCH₃ + 0.86 |
| | | CO₂ + 0.14 H₂O |
| | | NiO + H₂ → Ni + H₂O |
| 93 | ₂₉Cu | Cu + Cu²⁺ → 2 Cu⁺ |
| | Group 11 | Cu⁺ + Fe³⁺ → Cu²⁺ + Fe²⁺ |
| 94 | ₂₉Cu | Cu + CuCl₂ → 2 CuCl |
| | Group 11 | 2 CuCl + H₂ → 2 Cu + 2 HCl |
| 95 | ₂₉Cu | Cu + CuO → Cu₂O |
| | Group 11 | Cu₂O + H₂ → 2 Cu + H₂O |
| 96 | ₄₇Ag | Ag²⁺ + Ag → 2 Ag⁺ |
| | Group 11 | 2 Ag⁺ + S₂O₈²⁻ → 2 Ag²⁺ + 2 SO₄²⁻ |
| 97 | ₄₇Ag | Ag²⁺ + Ag → 2 Ag⁺ |
| | Group 11 | Ag⁺ + Cl⁻ → AgCl |
| | | 2 AgCl + H₂ → 2 Ag + 2 HCl |
| 98 | ₄₇Ag | AgF + KAgF₄ → 2 AgF₂ + KF |
| | Group 11 | 2 AgF₂ + 2 KF + F₂ → 2 KAgF₄ |
| 99 | ₄₇Ag | AgF + KAgF₄ → 2 AgF₂ + KF |
| | Group 11 | 2 AgF₂ → 2 AgF + F₂ |
| 100 | ₇₉Au | AuCl₃ + 2 Au → 3 AuCl |
| | Group 11 | 2 AuCl → 2 Au + Cl₂ |
| 101 | ₇₉Au | AuCl₃ + 2 Au → 3 AuCl |
| | Group 11 | AuCl + Cl₂ → AuCl₃ |
| 102 | ₄₈Cd | Cd + CdSO₄ → Cd₂SO₄ |
| | Group 12 | 3 Cd₂SO₄ + 2 HNO₃ + 3 H₂SO₄ → 6 CdSO₄ + 2 NO + 4 H₂O |
| 103 | ₈₀Hg | Hg + Hg²⁺ → Hg₂²⁺ |
| | Group 12 | Hg₂²⁺ + 2 Fe²⁺ → 2 Hg + 2 Fe³⁺ |
| 104 | ₈₀Hg | Hg + Hg²⁺ → Hg₂²⁺ |
| | Group 12 | Hg₂²⁺ + H₂ → 2 Hg + 2 H⁺ |
| 105 | ₈₀Hg | Hg + Hg²⁺ → Hg₂²⁺ |
| | Group 12 | Hg₂²⁺ + 2 Co³⁺ → 2 Hg²⁺ + 2 Co²⁺ |
| 106 | ₈₀Hg | Hg + Hg²⁺ → Hg₂²⁺ |
| | Group 12 | Hg₂²⁺ + S₂O₈²⁻ → 2 Hg²⁺ + 2 SO₄²⁻ |
| 107 | ₈₀Hg | Hg + HgCl₂ → Hg₂Cl₂ |
| | Group 12 | Hg₂Cl₂ + Fe → 2 Hg + FeCl₂ |
| 108 | ₈₀Hg | Hg + HgCl₂ → Hg₂Cl₂ |
| | Group 12 | Hg₂Cl₂ + Cl₂ → 2 HgCl₂ |
| 109 | ₅B | 2 B₂O₃ + 2 B → 3 B₂O₂ |
| | Group 13 | B₂O₂ + 2 NH₃ → 2 BN + 2 H₂O + H₂ |
| | | 2 BN + 3 H₂O → B₂O₃ + 2 NH₃ |
| 110 | ₅B | 2 B₂O₃ + 2 B → 3 B₂O₂ |
| | Group 13 | B₂O₂ + 2 H₂ → 2 B + 2 H₂O |
| 111 | ₅B | 7 B₂O₃ + 2 TiB₂ → 9 B₂O₂ + Ti₂O₃ |
| | Group 13 | B₂O₂ + 2 NH₃ → 2 BN + 2 H₂O + H₂ |
| | | 2 BN + 3 H₂O → B₂O₃ + 2 NH₃ |
| 112 | ₅B | 16 B + B₂O₃ → 3 B₆O |
| | Group 13 | 9 B₆O + 4 CaCO₃ → 4 CaB₆ + 4 B₄C + 7 B₂O₃ |
| 113 | ₅B | 16 B + B₂O₃ → 3 B₆O |
| | Group 13 | 5 B₆O + 4 CaO → 4 CaB₆ + 3 B₂O₃ |
| 114 | ₅B | 16 B + B₂O₃ → 3 B₆O |
| | Group 13 | B₆O + 4 O₂ → 3 B₂O₃ |
| 115 | ₅B | 16 B + B₂O₃ → 3 B₆O |
| | Group 13 | 2 B₆O → 10 B + B₂O₂ |
| | | B₂O₂ + 2 H₂ → 2 B + 2 H₂O |
| 116 | ₁₃Al | AlCl₃ + 2 Al → 3 AlCl |
| | Group 13 | AlCl + Cl₂ → AlCl₂ + Cl |
| | | AlCl₂ + Cl₂ → AlCl₃ + Cl |
| 117 | ₁₃Al | 2 AlCl₃ + Al → 3 AlCl₂ |
| | Group 13 | AlCl₂ + Cl₂ → AlCl₃ + Cl |
| 118 | ₃₁Ga | Ga₂O₃ + 4 Ga → 3 Ga₂O |
| | Group 13 | Ga₂O + O₂ → Ga₂O₃ |
| 119 | ₃₁Ga | Ga₂O₃ + 4 Ga → 3 Ga₂O |
| | Group 13 | Ga₂O + 2 NH₃ → 2 GaN + H₂O + 2 H₂ |
| | | 2 GaN + 3 H₂ → 2 Ga + 2 NH₃ |
| 120 | ₃₁Ga | 2 Ga + Ga₂S₂ → 2 Ga₂S |
| | Group 13 | Ga₂S + H₂ → 2 Ga + H₂S |
| 121 | ₃₁Ga | 2 Ga + Ga₂S₂ → 2 Ga₂S |
| | Group 13 | 3 Ga₂S + 6 HCl → 4 Ga + 2 GaCl₃ + 3 H₂S |
| 122 | ₃₁Ga | Ga + 2 GaCl₃ → 3 GaCl₂ |
| | Group 13 | 2 GaCl₂ + 2 NH₃ → 2 GaN + 4 HCl + H₂ |
| | | 2 GaN → 2 Ga + N₂ |
| 123 | ₆C | C + CO₂ → 2 CO |
| | Group 14 | CO + FeO → Fe + CO₂ |
| 124 | ₆C | C + CO₂ → 2 CO |
| | Group 14 | CO + H₂ → H₂O + C |
| 125 | ₆C | (CN)₂ + 2 CO₂ → 4 CO + N₂ |
| | Group 14 | CO + FeO → Fe + CO₂ |
| 126 | ₆C | C + CO₂ → 2 CO |
| | Group 14 | 5 CO + I₂O₅ → I₂ + 5 CO₂ |
| 127 | ₆C | CaC₂ + CO → CaO + 3 C |
| | Group 14 | C + Cl₂ + H₂O → CO + 2 HCl |
| 128 | ₆C | 2 CaC₂ + CS₂ → 2 CaS + 5 C |
| | Group 14 | C + 2S → CS₂ |
| 129 | ₆C | 2 CaC₂ + CCl₄ → 2 CaCl₂ + 5 C |
| | Group 14 | C + 2 Cl₂ → CCl₄ |
| 130 | ₆C | CH₄ + CO₂ → 2 CO + 2 H₂ |
| | Group 14 | CO + 3 H₂ → CH₄ + H₂O |
| 131 | ₆C | CH₄ + CO₂ → 2 CO + 2 H₂ |
| | Group 14 | CO + FeO → CO₂ + Fe |
| 132 | ₁₄Si | SiO₂ + Si → 2 SiO |
| | Group 14 | SiO + CO → SiO₂ + C |
| 133 | ₁₄Si | SiO₂ + Si → 2 SiO |
| | Group 14 | SiO + C → Si + CO |
| 134 | ₁₄Si | SiO₂ + Si → 2 SiO |
| | Group 14 | Mg₂Si + 2 SiO → 3 Si + 2 MgO |
| 135 | ₁₄Si | Si + 3 SiCl₄ + 2 H₂ → 4 SiHCl₃ |
| | Group 14 | SiHCl₃ + H₂ → Si + 3 HCl |
| 136 | ₁₄Si | Si + 3 SiCl₄ + 2 H₂ → 4 SiHCl₃ |
| | Group 14 | SiHCl₃ + Cl₂ → SiCl₄ + HCl |
| 137 | ₃₂Ge | GeCl₄ + Ge → 2 GeCl₂ |
| | Group 14 | GeCl₂ + Cl₂ → GeCl₄ |
| 138 | ₃₂Ge | GeO₂ + Ge → 2 GeO |
| | Group 14 | 2 GeO + O₂ → 2 GeO₂ |
| 139 | ₅₀Sn | Sn⁴⁺ + Sn → 2 Sn²⁺ |
| | Group 14 | Sn²⁺ + I₂ → 2 I⁻ + Sn⁴⁺ |
| 140 | ₅₀Sn | Sn⁴⁺ + Sn → 2 Sn²⁺ |
| | Group 14 | Sn²⁺ + Fe → Fe²⁺ + Sn |
| 141 | ₈₂Pb | Pb + PbO₂ + 2 H₂SO₄ → 2 PbSO₄ + 2 H₂O |
| | Group 14 | PbSO₄ + 4 CO → PbS + 4 CO₂ |
| | | PbSO₄ + PbS → 2 Pb + 2 SO₂ |
| 142 | ₈₂Pb | Pb + PbO₂ + 2 H₂SO₄ → 2 PbSO₄ + 2 H₂O |
| | Group 14 | PbSO₄ + 2 H₂ → Pb + SO₂ + 2 H₂O |
| 143 | ₈₂Pb | Pb + PbO₂ + 2 H₂SO₄ → 2 PbSO₄ + 2 H₂O |
| | Group 14 | PbSO₄ → PbO₂ + SO₂ |
| 144 | ₈₂Pb | 2 PbO + PbO₂ → Pb₃O₄ |
| | Group 14 | 2 Pb₃O₄ → 6 PbO + O₂ |
| 145 | ₇N | HNO₂ + HNO₃ → 2 NO₂ + H₂O |
| | Group 15 | 2 NO₂ + Cu + 2 H⁺ → 2 HNO₂ + Cu²⁺ |
| 146 | ₇N | NH₄NO₃ → 2 H₂O + N₂O |
| | Group 15 | N₂O + H₂SO₄ → 2 NO + SO₂ + H₂O |
| | | 2 NO + O₂ → 2 NO₂ |
| | | 4 NO₂ + 2 H₂O + O₂ → 4 HNO₃ |
| | | HNO₃ + NH₃ → NH₄NO₃ |
| 147 | ₇N | 2 NH₄NO₃ → 2 N₂ + O₂ + 4 H₂O |
| | Group 15 | N₂ + 3 Mg → Mg₃N₂ |
| | | Mg₃N₂ + 6 H₂O → 3 Mg(OH)₂ + 2 NH₃ |
| | | HNO₃ + NH₃ → NH₄NO₃ |
| 148 | ₇N | N₂O₅ + NO → 3 NO₂ |
| | Group 15 | 2 NO₂ → 2 NO + O₂ |
| 149 | ₇N | N₂O₅ + NO → 3 NO₂ |
| | Group 15 | 2 NO₂ + O₃ → N₂O₅ + O₂ |
| 150 | ₇N | NO₂ + NO → N₂O₃ |
| | Group 15 | N₂O₃ + 2 HNO₃ → 4 NO₂ + H₂O |
| 151 | ₇N | NO₂ + NO → N₂O₃ |
| | Group 15 | N₂O₃ + 2 Hg + H₂SO₄ → 2 NO + Hg₂SO₄ + H₂O |
| 152 | ₇N | NH₂OH + HNO₂ → N₂O + 2 H₂O |
| | Group 15 | N₂O + H₂SO₄ → 2 NO + SO₂ + H₂O |
| | | 2 NO + O₂ → 2 NO₂ |
| | | NO₂ + NO + H₂O → 2 HNO₂ |
| 153 | ₁₅P | 2 PH₃ + 2 PCl₃ → P₄ + 6 HCl |
| | Group 15 | P₄ + 6 Cl₂ → 4 PCl₃ |
| 154 | ₁₅P | 2 PH₃ + 2 PCl₃ → P₄ + 6 HCl |
| | Group 15 | P₄ + 6 H₂ → 4 PH₃ |
| 155 | ₁₅P | 2 PH₃ + 2 PCl₃ → P₄ + 6 HCl |
| | Group 15 | P₄ + 3 O₂ + 6 H₂O → 4 H₃PO₃ |
| | | H₃PO₃ + 3 Zn + 6 H⁺ → PH₃ + 3 Zn²⁺ + 3 H₂O |
| 156 | ₁₅P | 2 PH₃ + 2 PCl₃ → P₄ + 6 HCl |
| | Group 15 | 2 P₄ + 3 Ba(OH)₂ + 6 H₂O → 3 Ba(H₂PO₂)₂ + 2 PH₃ |
| | | Ba(H₂PO₂)₂ + H₂SO₄ → 2 H₃PO₂ + BaSO₄ |
| | | 2 H₃PO₂ → PH₃ + H₃PO₄ |
| 157 | ₁₅P | 2 PH₃ + 2 PCl₃ → P₄ + 6 HCl |
| | Group 15 | P₄ + 4 B → 4 BP |
| | | BP + NH₃ → PH₃ + BN |
| 158 | ₁₅P | 2 PH₃ + 2 PCl₃ → P₄ + 6 HCl |
| | Group 15 | P₄ + 4 I₂ → 2 P₂I₄ |
| | | 13 P₄ + 10 P₂I₄ + 128 H₂O → 40 PH₄I + 32 H₃PO₄ |
| | | PH₄I → PH₃ + HI |
| 159 | ₁₅P | PH₃ + 3 PCl₅ → 4 PCl₃ + 3 HCl |
| | Group 15 | PCl₃ + Cl₂ → PCl₅ |
| 160 | ₁₅P | 3 H₃PO₄ + 2 P + 3 H₂O → 5 H₃PO₃ |
| | Group 15 | 4 H₃PO₃ → 3 H₃PO₄ + PH₃ |
| 161 | ₁₅P | 3 PCl₅ + 3 PH₄I → PI₃ + PCl₃ + P₄ + 12 HCl |
| | Group 15 | PCl₃ + Cl₂ → PCl₅ |
| | | P₄ + 10 Cl₂ → 4 PCl₅ |
| 162 | ₃₃As | 3 H₃AsO₄ + 5 AsH₃ → 8 As + 12 H₂O |
| | Group 15 | 6 As + 5 K₂Cr₂O₇ + 20 H₂SO₄ → 3 As₂O₅ + 5 Cr₂(SO₄)₃ + 5 K₂SO₄ + |
| | | 20 H₂O |
| | | As₂O₅ + 3 H₂O → 2 H₃AsO₄ |
| 163 | ₃₃As | 3 H₃AsO₄ + 5 AsH₃ → 8 As + 12 H₂O |
| | Group 15 | 2 As + 5 Cl₂ + 8 H₂O → 2 H₃AsO₄ + 10 HCl |
| 164 | ₃₃As | 3 H₃AsO₄ + 5 AsH₃ → 8 As + 12 H₂O |
| | Group 15 | 2 As + 5 NaClO + 3 H₂O → 2 H₃AsO₄ + 5 NaCl |
| 165 | ₃₃As | 3 H₃AsO₄ + 5 AsH₃ → 8 As + 12 H₂O |
| | Group 15 | 2 As + 6 HCOONa → 2 AsH₃ + 3 Na₂C₂O₄ |
| 166 | ₃₃As | AsH₃ + AsCl₃ → 2 As + 3 HCl |
| | Group 15 | 2 As + 3 HgCl₂ → 2 AsCl₃ + 3 Hg |
| 167 | ₃₃As | AsH₃ + AsCl₃ → 2 As + 3 HCl |
| | Group 15 | 2 As + 3 H₂ → 2 AsH₃ |
| 168 | ₃₃As | 4 AsI₃ + 2 As → 3 As₂I₄ |
| | Group 15 | As₂I₄ + I₂ → 2 AsI₃ |
| 169 | ₃₃As | As₄ + 4 Co₃As₂ → 12 CoAs |
| | Group 15 | 20 CoAs → 3 As₄ + 4 Co₅As₂ |
| | | 2 Co₅As₂ → As₄ + 10 Co |
| 170 | ₈O | O₂ + 2 Na₂O → 2 Na₂O₂ |
| | Group 16 | Na₂O₂ + H₂SO₄ → H₂O₂ + Na₂SO₄ |
| | | H₂O₂ + Cl₂ → O₂ + 2 HCl |
| 171 | ₈O | H₂O + O₃ → 2 OH + O₂ |
| | Group 16 | OH + HCl → H₂O + Cl |
| 172 | ₈O | H₂O + O₃ → H₂O₂ + O₂ |
| | Group 16 | H₂O₂ + H₂S → 2 H₂O + S |
| 173 | ₈O | H₂O + O₃ → H₂O₂ + O₂ |
| | Group 16 | H₂O₂ + Cl₂ → O₂ + 2 HCl |
| | | 3 O₂ → 2 O₃ |
| 174 | ₈O | OF₂ + H₂O → O₂ + 2 HF |
| | Group 16 | O₂ + 2 H₂ → 2 H₂O |
| 175 | ₈O | 2 Na₂O + O₂ → 2 Na₂O₂ |
| | Group 16 | Na₂O₂ + 2 HCl → 2 NaCl + H₂O₂ |
| | | H₂O₂ + Cl₂ → 2 HCl + O₂ |
| 176 | ₈O | 2 Na₂O + O₂ → 2 Na₂O₂ |
| | Group 16 | Na₂O₂ + 2 Na → 2 Na₂O |
| 177 | ₁₆S | 2 H₂S + SO₂ → 3 S + 2 H₂O |
| | Group 16 | S + H₂ → H₂S |
| 178 | ₁₆S | SO₂ + 2 H₂S → 3 S + 2 H₂O |
| | Group 16 | S + O₂ → SO₂ |
| 179 | ₁₆S | Na₂SO₃ + S → Na₂S₂O₃ |
| | Group 16 | 3 Na₂S₂O₃ + 6 NaOH → 2 Na₂S + 4 Na₂SO₃ + 3 H₂O |
| 180 | ₁₆S | Na₂SO₃ + S → Na₂S₂O₃ |
| | Group 16 | 3 Na₂S₂O₃ + 4 NaOH + 2 NaNO₂ + H₂O → 6 Na₂SO₃ + 2 NH₃ |
| 181 | ₁₆S | HOSCN + SCN⁻ + H⁺ → (SCN)₂ + H₂O |
| | Group 16 | 3 (SCN)₂ + 4 H₂O → H₂SO₄ + HCN + 5 SCN⁻ + 5H⁺ |
| 182 | ₁₆S | HOSCN + SCN⁻ + H⁺ → (SCN)₂ + H₂O |
| | Group 16 | (SCN)₂ + H₂S → S + 2 SCN⁻ + 2 H⁺ |
| 183 | ₁₆S | 2 H₂SO₄ + S → 3 SO₂ + 2 H₂O |
| | Group 16 | 2 SO₂ + O₂ + 2 H₂O → 2 H₂SO₄ |
| 184 | ₁₆S | 2 H₂SO₄ + S → 3 SO₂ + 2 H₂O |
| | Group 16 | SO₂ + 2 CO → S + 2 CO₂ |
| 185 | ₁₆S | CS₂ + 3 SO₃ → COS + 4 SO₂ |
| | Group 16 | SO₂ + 3 Fe₂O₃ → SO₃ + 2 Fe₃O₄ |
| 186 | ₁₆S | CS₂ + 3 SO₃ → COS + 4 SO₂ |
| | Group 16 | 2 COS + C → CS₂ + 2 CO |
| | | 2 SO₂ + 2 C → S₂ + 2 CO₂ |
| | | S₂ + C → CS₂ |
| 187 | ₁₆S | SO₂ + 3 S → 2 S₂O |
| | Group 16 | S₂O + O₃ → 2 SO₂ |
| 188 | ₃₄Se | H₂SeO₃ + 2 H₂Se → 3 Se + 3 H₂O |
| | Group 16 | 3 Se + 4 HNO₃ + H₂O → 3 H₂SeO₃ + 4 NO |
| 189 | ₃₄Se | H₂SeO₃ + 2 H₂Se → 3 Se + 3 H₂O |
| | Group 16 | Se + H₂ → H₂Se |
| 190 | ₃₄Se | Se + 2 H₂SeO₄ + H₂O → 3 H₂SeO₃ |
| | Group 16 | 3 H₂SeO₃ + HClO₃ → 3 H₂SeO₄ + HCl |
| 191 | ₃₄Se | Se + 2 H₂SeO₄ + H₂O → 3 H₂SeO₃ |
| | Group 16 | H₂SeO₃ + 2 NH₂OH → Se + N₂O + 4 H₂O |
| 192 | ₃₄Se | Se₂Cl₂ + ZnSe → 3 Se + ZnCl₂ |
| | Group 16 | 2 Se + Cl₂ → Se₂Cl₂ |
| 193 | ₃₄Se | Se₂Cl₂ + ZnSe → 3 Se + ZnCl₂ |
| | Group 16 | Se + Zn → ZnSe |
| 194 | ₃₄Se | 3 Se + SeCl₄ → 2 Se₂Cl₂ |
| | Group 16 | Se₂Cl₂ + 2 FeCl₂ → 2 Se + 2 FeCl₃ |
| 195 | ₃₄Se | 3 Se + SeCl₄ → 2 Se₂Cl₂ |
| | Group 16 | Se₂Cl₂ + 3 Cl₂ → 2 SeCl₄ |
| 196 | ₅₂Te | Te + TeCl₄ → 2 TeCl₂ |
| | Group 16 | TeCl₂ + Cl₂ → TeCl₄ |
| 197 | ₅₂Te | 2 H₂Te + TeO₂ → 3 Te + 2 H₂O |
| | Group 16 | Te + 2 H₂O → TeO₂ + 2 H₂ |
| 198 | ₅₂Te | 2 H₂Te + TeCl₄ → 3 Te + 4 HCl |
| | Group 16 | Te + 2 Cl₂ → TeCl₄ |
| 199 | ₅₂Te | Te + 2 TeF₆ → 3 TeF₄ |
| | Group 16 | TeF₄ + 2 H₂S → Te + 4 HF + 2 S |
| 200 | ₅₂Te | Te + 2 H₂TeO₄ + H₂O → 3 H₂TeO₃ |
| | Group 16 | H₂TeO₃ + 2 SO₂ + H₂O → Te + 2 H₂SO₄ |
| 201 | ₅₂Te | Te + 2 H₂TeO₄ + H₂O → 3 H₂TeO₃ |
| | Group 16 | 3 H₂TeO₃ + K₂Cr₂O₇ + 4 H₂SO₄ → 3 H₂TeO₄ + |
| | | Cr₂(SO₄)₃ + K₂SO₄ + 4 H₂O |
| 202 | ₁₇Cl | HCl + HOCl → Cl₂ + H₂O |
| | Group 17 | Cl₂ + H₂ → 2 HCl |
| 203 | ₁₇Cl | HClO₄ + 7 HCl → 4 Cl₂ + 4 H₂O |
| | Group 17 | Cl₂ + H₂S → 2 HCl + S |
| 204 | ₁₇Cl | HClO₃ + 5 HCl → 3 Cl₂ + 3 H₂O |
| | Group 17 | Cl₂ + 2 HBr → 2 HCl + Br₂ |
| 205 | ₁₇Cl | Cl₂ + ClF₃ → 3 ClF |
| | Group 17 | 4 ClF + 2 H₂O → 2 Cl₂ + 4 HF + O₂ |
| 206 | ₁₇Cl | Cl₂ + ClF₃ → 3 ClF |
| | Group 17 | ClF + F₂ → ClF₃ |
| 207 | ₁₇Cl | HClO₂ + HClO₃ → 2 ClO₂ + H₂O |
| | Group 17 | 2 ClO₂ + H₂O₂ → 2 HClO₂ + O₂ |
| 208 | ₁₇Cl | HClO₂ + HClO₃ → 2 ClO₂ + H₂O |
| | Group 17 | 6 ClO₂ + 2 H₂O → 4 HClO₃ + Cl₂ + O₂ |
| 209 | ₃₅Br | HBrO₂ + HBrO₃ → 2 BrO₂^{•} + H₂O |
| | Group 17 | BrO₂^{•} + H⁺ + Ce³⁺ → HBrO₂ + Ce⁴⁺ |
| 210 | ₃₅Br | HBrO + HBrO₂ → Br₂O₂ + H₂O |
| | Group 17 | Br₂O₂ → 2 BrO^{•} |
| | | BrO^{•} + H⁺ + Ce³⁺ → HBrO + Ce⁴⁺ |
| 211 | ₃₅Br | HBr + HBrO → Br₂ + H₂O |
| | Group 17 | Br₂ + H₂ → 2 HBr |
| 212 | ₃₅Br | HBr + HBrO → Br₂ + H₂O |
| | Group 17 | Br₂ + Cl₂ + 2 H₂O → 2 HBrO + 2 HCl |
| 213 | ₃₅Br | 5 HBr + HBrO₃ → 3 Br₂ + 3 H₂O |
| | Group 17 | Br₂ + HNO₂ + H₂O → 2 HBr + HNO₃ |
| 214 | ₃₅Br | 5 HBr + HBrO₃ → 3 Br₂ + 3 H₂O |
| | Group 17 | Br₂ + 5 HOCl + H₂O → 2 HBrO₃ + 5 HCl |
| 215 | ₅₃I | HIO₂ + I⁻ + H⁺ → 2 HOI |
| | Group 17 | HOI + HClO₂ → HIO₂ + HOCl |
| 216 | ₅₃I | HIO₂ + I⁻ + H⁺ → 2 HOI |
| | Group 17 | HOI + HSO₃⁻ → I⁻ + HSO₄⁻ + H⁺ |
| 217 | ₅₃I | HIO₂ + I⁻ + H⁺ → 2 HOI |
| | Group 17 | 3 HOI + 3 NaOH → 2 I⁻ + IO₃⁻ + 3 Na⁺ + 3 H₂O |
| 218 | ₅₃I | IO₃⁻ + 5 I⁻ + 6 H⁺ → 3 I₂ + 3 H₂O |
| | Group 17 | 5 ClO₂⁻ + 2 I₂ + 2 H₂O → 5 Cl⁻ + 4 IO₃⁻ + 4 H⁺ |
| 219 | ₅₃I | IO₃ + 5 I⁻ + 6 H⁺ → 3 I₂ + 3 H₂O |
| | Group 17 | I₂ + H₂S → 2 I⁻ + 2 H⁺ + S |
| 220 | ₅₃I | HOI + I⁻ + H⁺ → I₂ + H₂O |
| | Group 17 | I₂ + H₂SO₃ + H₂O → 2 I⁻ + 4 H⁺ + SO₄²⁻ |
| 221 | ₅₃I | HOI + I⁻ + H⁺ → I₂ + H₂O |
| | Group 17 | I₂ + 2 HOCl → 2 HOI + Cl₂ |
| 222 | ₅₃I | HIO₃ + 2 I₂ + 5 HCl → 5 ICl + 3 H₂O |
| | Group 17 | 2 ICl → I₂ + Cl₂ |
| 223 | ₅₄Xe | XeF₄ + Xe → 2 XeF₂ |
| | Group 18 | XeF₂ + F₂ → XeF₄ |
| 224 | ₅₄Xe | XeF₄ + Xe → 2 XeF₂ |
| | Group 18 | 2 XeF₂ + 2 H₂O → 2 Xe + O₂ + 4 HF |
| 225 | ₅₄Xe | 2 XeF₆ + Xe → 3 XeF₄ |
| | Group 18 | XeF₄ + F₂ → XeF₆ |
| 226 | ₅₄Xe | 2 XeF₆ + Xe → 3 XeF₄ |
| | Group 18 | XeF₄ + 2 H₂ → Xe + 4 HF |

The arrows in this table do not mean that the reactions are irreversible, but just indicate the autocatalytic direction. Autocatalysts are shown by bold fonts. Sometimes, a chemical species may contain multiple atoms of the same element but these atoms have different oxidation numbers, for example Mn₃O₄ and S₂O₃²⁻; in these cases, the average oxidation number of the element is considered. Ln: lanthanoid. An: actinoid.
Note:
Table 2 encompasses all the comproportionation-based autocatalytic cycles in Table 1 as well as additional comproportionation-based autocatalytic cycles.

TABLE 3
Examples of Broad-sense Comproportionation-
based Autocatalytic Cycles.

| Serial | Reactions |
|---|---|
| B1 | O₂SCl₂ + O₂SF₂ → 2 O₂SFCl |
| | O₂SFCl + KSO₂F → O₂SF₂ + KCl + SO₂ |
| B2 | Ca(HCO₃)₂ + H⁺ + HSO₃⁻ → 2 H₂CO₃ + CaSO₃ |
| | CaCO₃ + H₂CO₃ → Ca(HCO₃)₂ |
| B3 | Ca(HCO₃)₂ + CaO → 2 CaCO₃ + H₂O |
| | CaCO₃ + H₂CO₃ → Ca(HCO₃)₂ |
| B4 | Ca(HCO₃)₂ + CaO → 2 CaCO₃ + H₂O |
| | CaCO₃ → CaO + CO₂ |
| B5 | 2 CaO + CaC₂ → 3 Ca + 2 CO |
| | Ca + 2 C → CaC₂ |
| B6 | 2 CaO + CaC₂ → 3 Ca + 2 CO |
| | 2 Ca + O₂ → 2 CaO |
| B7 | Ca(OH)₂ + H₂CO₃ → CaCO₃ + 2 H₂O |
| | CaO + H₂O → Ca(OH)₂ |
| B8 | Ca₃(PO₄)₂ + 4 H₃PO₄ → 3 Ca(H₂PO₄)₂ |
| | Ca(H₂PO₄)₂ + 2 CaCO₃ → Ca₃(PO₄)₂ + 2 CO₂ + 2 H₂O |
| B9 | Ca₃(PO₄)₂ + 4 H₃PO₄ → 3 Ca(H₂PO₄)₂ |
| | Ca(H₂PO₄)₂ + 2 HCl → CaCl₂ + 2 H₃PO₄ |
| B10 | Na₂S + H₂S → 2 NaHS |
| | NaHS + NaOH → Na₂S + H₂O |
| B11 | Na₂S + H₂S → 2 NaHS |
| | NaHS + HCl → H₂S + NaCl |
| B12 | Na₂CO₃ + H₂CO₃ → 2 NaHCO₃ |
| | NaHCO₃ + NaOH → Na₂CO₃ + H₂O |
| B13 | Na₂O + H₂O → 2 NaOH |
| | 2 NaOH + 2 Na → 2 Na₂O + H₂ |
| B14 | 5 NaN₃ + NaNO₃ → 3 Na₂O + 8 N₂ |
| | Na₂O + H₂O → 2 NaOH |
| | NaOH + HNO₃ → NaNO₃ + H₂O |
| B15 | 2 ZnO + ZnS + 3 Se → 3 ZnSe + SO₂ |
| | 2 ZnSe + 3 O₂ → 2 ZnO + 2 SeO₂ |
| B16 | ZnS + 2 ZnO → 3 Zn + SO₂ |
| | Zn + 2 H₂O → Zn(OH)₂ + H₂ |
| | Zn(OH)₂ → ZnO + H₂O |
| B17 | ZnS + 2 ZnO → 3 Zn + SO₂ |
| | Zn + 2 HCl → ZnCl₂ + H₂ |
| | ZnCl₂ + H₂S → ZnS + 2 HCl |
| B18 | 4 ZnO + ZnCl₂ + 5 H₂O → Zn₅(OH)₈Cl₂•H₂O |
| | Zn₅(OH)₈Cl₂•H₂O + 8 HCl → 5 ZnCl₂ + 9 H₂O |
| B19 | 6 NaAlO₂ + Al₂(SO₄)₃ + 12 H₂O → 3 Na₂SO₄ + 8 Al(OH)₃ |
| | Al(OH)₃ + NaOH → NaAlO₂ + 2 H₂O |
| B20 | Cu₂S + 2 CuO → SO₂ + 4 Cu |
| | 2 Cu + 2 NO → N₂ + 2 CuO |
| B21 | 3 AsS₂⁻ + AsO₃³⁻ + 6 H⁺ → 2 As₂S₃ + 3 H₂O |
| | As₂S₃ + HS⁻ + NH₃ → 2 AsS₂⁻ + NH₄⁺ |
| B22 | AsCl₃ + As₂O₃ → 3 AsOCl |
| | AsOCl + HCl → As(OH)Cl₂ |
| | As(OH)Cl₂ + HCl → AsCl₃ + H₂O |
| B23 | H₂S₂O₇ + H₂O → 2 H₂SO₄ |
| | H₂SO₄ + SO₃ → H₂S₂O₇ |
| B24 | H₂Cr₂O₇ + H₂O → 2 H₂CrO₄ |
| | H₂CrO₄ + CrO₃ → H₂Cr₂O₇ |
| B25 | FeS₂ + Fe → 2 FeS |
| | FeS + C + CaO → Fe + CO + CaS |
| B26 | 2 CoO + Co(CN)₂ → 3 Co + 2 CO + N₂ |
| | Co + H₂O → CoO + H₂ |
| B27 | 5 B₂H₆ + 2 BBr₃ → 6 B₂H₅Br |
| | B₂H₅Br + (CH₃)₂SbH → B₂H₆ + (CH₃)₂SbBr |
| B28 | B₄C + BO → 5 B + CO |
| | B + N₂O → BO + N₂ |
| B29 | B₄C + BO → 5 B + CO |
| | 4 B + C → B₄C |
| B30 | B₂O₃ + 2 KBH₄ → 4 B + 2 KOH + H₂O + 2 H₂ |
| | 4 B + 3 O₂ → 2 B₂O₃ |
| B31 | 6 AlN + Al₂(SO₄)₃ + 24 H₂O → 8 Al(OH)₃ + 3 (NH₄)₂SO₄ |
| | 2 Al(OH)₃ + 3 H₂SO₄ → Al₂(SO₄)₃ + 6 H₂O |
| B32 | 6 AlN + Al₂(SO₄)₃ + 24 H₂O → 8 Al(OH)₃ + 3 (NH₄)₂SO₄ |
| | 2 Al(OH)₃ → Al₂O₃ + 3 H₂O |
| | Al₂O₃ + 3 C + N₂ → 2 AlN + 3 CO |
| B33 | Al₂(SO₄)₃ + 2 Na₃AlF₆ → 4 AlF₃ + 3 Na₂SO₄ |
| | AlF₃ + 3 H₂O → Al(OH)₃ + 3 HF |
| | 2 Al(OH)₃ + 3 H₂SO₄ → Al₂(SO₄)₃ + 6 H₂O |
| B34 | AlCl₃ + 3 LiAlH₄ → 4 AlH₃ + 3 LiCl |
| | 2 AlH₃ + 2 BCl₃ → 2 AlCl₃ + B₂H₆ |
| B35 | CO₂ + CS₂ + 4 Cu → 2 CO + 2 Cu₂S |
| | CO + FeO → Fe + CO₂ |
| B36 | CO + H₂ + CaCN₂ → CaO + 2 HCN |
| | HCN + H₂O → CO + NH₃ |
| B37 | PbS + 3 PbSO₄ → 4 PbO + 4 SO₂ |
| | PbO + H₂S → PbS + H₂O |
| B38 | PbS + 3 PbSO₄ → 4 PbO + 4 SO₂ |
| | PbO + SO₃ → PbSO₄ |
| B39 | PbS + 2 PbO → 3 Pb + SO₂ |
| | Pb + H₂S → PbS + H₂ |
| B40 | PbS + 2 PbO → 3 Pb + SO₂ |
| | 2 Pb + O₂ → 2 PbO |
| B41 | Pb(CH₃)₃(C₂H₅) + Pb(CH₃)(C₂H₅)₃ → 2 Pb(CH₃)₂(C₂H₅)₂ |
| | Pb(CH₃)₄ + Pb(CH₃)₂(C₂H₅)₂ → 2 Pb(CH₃)₃(C₂H₅) |
| B42 | Pb(CH₃)₃(C₂H₅) + Pb(CH₃)(C₂H₅)₃ → 2 Pb(CH₃)₂(C₂H₅)₂ |
| | Pb(C₂H₅)₄ + Pb(CH₃)₂(C₂H₅)₂ → 2 Pb(CH₃)(C₂H₅)₃ |
| B43 | 5 H₃PO₄ + POCl₃ → 3 H₄P₂O₇ + 3 HCl |
| | H₄P₂O₇ + H₂O → 2 H₃PO₄ |
| B44 | 2 HF + SiF₄ → H₂SiF₆ |
| | H₂SiF₆ + 4 H₂O → 6 HF + H₄SiO₄ |

The arrows in this table do not mean that the reactions are irreversible, but just indicate the autocatalytic direction. Autocatalysts are shown by bold fonts.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

What is claimed is:

1. A method for conducting an autocatalytic cycle, the method comprising:
(a) carrying out a comproportionation reaction by reacting a first reactant M₁ and a second reactant M₂ to form a product M₃, wherein M₁, M₂, and M₃ each comprise at least one chemical element in common and the product M₃ is produced in stoichiometric excess; and
(b) carrying out an auxiliary reaction by converting the product M₃ to M₁ or M₂.

2. The method of claim 1, wherein the autocatalytic cycle does not comprise: a chemical reaction involving bromic acid and cerium ions as chemical species therein; reacting formaldehyde to form glycoaldehyde; oxidizing pyrite in an aqueous solution; oxidizing oxalic acid by permanganate; a chemical reaction involving iodous acid and chlorous acid as chemical species therein; and a chemical reaction involving mercury ions, iron ions, and colloidal mercury as chemical species therein.

3. The method of claim 1, wherein M₁, M₂, and M₃ are different chemical species from one another.

4. The method of claim 1, wherein the at least one chemical element in common is in a high oxidation state in M₁, in a low oxidation state in M₂, and in an intermediate oxidation state in M₃.

5. The method of claim 1, wherein the auxiliary reaction is an oxidation auxiliary reaction in which the product M₃ is converted to M₁ or M₂ using an oxidant.

6. The method of claim 1, wherein the auxiliary reaction is a reduction auxiliary reaction in which the product M₃ is converted to M₁ or M₂ using a reductant.

7. The method of claim 1, wherein a total number of chemical reactions in the autocatalytic cycle is not more than 5.

8. The method of claim 1, wherein a total number of chemical reactions in the autocatalytic cycle is 2.

9. The method of claim 1, wherein the autocatalytic cycle comprises at least two different comproportionation reactions, wherein the comproportionation reaction of step (a) is one of the at least two, and further wherein there is at least one shared chemical species among all chemical reactions within the autocatalytic cycle.

10. The method of claim 1, wherein at least one chemical reaction within the autocatalytic cycle consists of inorganic chemical species.

11. The method of claim 1, wherein all chemical reactions within the autocatalytic cycle consist of inorganic chemical species.

12. The method of claim 1, further comprising suppressing a side chemical reaction between a non-catalytic reactant of the comproportionation reaction of step (a) and a reactant of the auxiliary reaction of step (b).

13. The method of claim 12, wherein the suppressing step is carried out by kinetically separating the non-catalytic reactant and the reactant, spatially separating the non-catalytic reactant and the reactant, temporally separating the non-catalytic reactant and the reactant, or a combination thereof.

14. A chemical reactor system configured to conduct an autocatalytic cycle, the system comprising a reactor region in which (a) a comproportionation reaction is carried out by reacting a first reactant M₁ and a second reactant M₂ to form a product M₃, wherein M₁, M₂, and M₃ each comprise at least one chemical element in common and the product M₃ is produced in stoichiometric excess; and in which (b) an auxiliary reaction is carried out by converting the product M₃ to M₁ or M₂.

15. The chemical reactor system of claim 14, wherein the autocatalytic cycle does not comprise: a chemical reaction involving bromic acid and cerium ions as chemical species therein; reacting formaldehyde to form glycoaldehyde; oxidizing pyrite in an aqueous solution; oxidizing oxalic acid by permanganate; a chemical reaction involving iodous acid and chlorous acid as chemical species therein; and a chemical reaction involving mercury ions, iron ions, and colloidal mercury as chemical species therein.

16. The chemical reactor system of claim 15, wherein the system is further configured to suppress a side chemical reaction between a non-catalytic reactant of the comproportionation reaction of (a) and a reactant of the auxiliary reaction of (b).

17. The chemical reactor system of claim 16, wherein the system is configured to kinetically separate the non-catalytic reactant and the reactant, spatially separate the non-catalytic reactant and the reactant, temporally separate the non-catalytic reactant and the reactant, or a combination thereof.

18. The chemical reactor system of claim 17, wherein the reactor region is configured as two separate reactor regions in fluid communication with one another but which spatially separate the non-catalytic reactant into one of the two separate reactor regions and the reactant into the other of the two separate reactor regions.

19. The chemical reactor system of claim 17, wherein the reactor region is a flow reactor region comprising an inlet valve and an outlet valve and the chemical reactor system further comprises a controller configured to control operation of the inlet and outlet valves according to a temporal profile to prevent the non-catalytic reactant and the reactant from being present in the flow reactor region at the same time.

20. A method of identifying an autocatalytic cycle, the method comprising selecting a comproportionation reaction comprising a first reactant M₁ and a second reactant M₂ capable of chemically reacting to form a product M₃ in stoichiometric excess, wherein M₁, M₂, and M₃ each comprise at least one chemical element in common; and selecting an auxiliary reaction that is capable of converting the product M₃ to the first reactant M₁ or the second reactant M₂, wherein the autocatalytic cycle does not comprise: a chemical reaction involving bromic acid and cerium ions as chemical species therein; reacting formaldehyde to form glycoaldehyde; oxidizing pyrite in an aqueous solution; oxidizing oxalic acid by permanganate; a chemical reaction involving iodous acid and chlorous acid as chemical species therein; and a chemical reaction involving mercury ions, iron ions, and colloidal mercury as chemical species therein.
